(19) United States
(12) Patent Application Publication
(10) Pub. No.: US 2019/0234492 A1
(43) Pub. Date: Aug. 1, 2019

(54) VEHICLE DRIVE DEVICE

(71) Applicant: AISIN AW CO., LTD., Anjo-shi, Aichi-ken (JP)

(72) Inventors: Satoru KASUYA, Nishio (JP); Hiroshi KATO, Kariya (JP); Jun SUZUKI, Okazaki (JP)

(73) Assignee: AISIN AW CO., LTD., Anjo-shi, Aichi-ken (JP)

(21) Appl. No.: 16/332,177

(22) PCT Filed: Oct. 31, 2017
(86) PCT No.: PCT/JP2017/039369

§ 371 Date: Mar. 11, 2019

(30) Foreign Application Priority Data
Oct. 31, 2016 (JP) 2016-213727

(51) Int. Cl. F16H 3/66; F16H 3/72

(52) U.S. Cl. CPC F16H 3/66; F16H 2200/2097; F16H 3/72

(57) ABSTRACT

A vehicle drive device that includes the rotating electrical machine disposed at such a position that at least a part of the rotating electrical machine overlaps the speed change mechanism as viewed in a radial direction of the rotating electrical machine, and the rotating electrical machine disposed on the first side in the axial direction with respect to the input gear so as to overlap the input gear or a member that rotates with the input gear as viewed in the axial direction.

### BACKGROUND

The present disclosure relates to vehicle drive devices including an input member drivingly coupled to an internal combustion engine, an output member drivingly coupled to wheels, a rotating electrical machine, and an automatic transmission.

An example of vehicle drive devices for driving a vehicle including both an internal combustion engine and a rotating electrical machine as driving force sources for wheels is described in the specification of German Patent Application Publication No. 102012019971. As shown in FIG. 1 of German Patent Application Publication No. 102012019971, a transmission (18) included in a vehicle drive device of German Patent Application Publication No. 102012019971 includes an input shaft (26) disposed coaxially with an internal combustion engine (12), and a first output shaft (28) and a second output shaft (30) which are disposed parallel to the input shaft (26). Each of the first output shaft (28) and the second output shaft (30) has a gear meshing with a gear disposed on the input shaft (26) and a gear meshing with a ring gear (38) of a differential unit (20). A rotating electrical machine (40) included in this vehicle drive device is disposed on a different axis from the input shaft (26), the first output shaft (28), and the second output shaft (30) and is coupled to the transmission (18) by using a coupling device (50).

In view of vehicle mountability of vehicle drive devices, it is preferable that the overall device size be as small as possible. However, as can be seen from the positional relationship of the parts of the vehicle drive device as viewed in the axial direction as shown in FIGS. 4 to 8 of German Patent Application Publication No. 102012019971, the position and configuration of the rotating electrical machine described in German Patent Application Publication No. 102012019971 tends to result in an increase in size of the vehicle drive device in a direction perpendicular to the axial direction.

### SUMMARY

An exemplary aspect of the disclosure implements a vehicle drive device capable of restraining an increase in device size which is caused by including a rotating electrical machine.

In view of the above, a vehicle drive device includes an input drivingly coupled to an internal combustion engine, an output drivingly coupled to wheels, a rotating electrical machine, and an automatic transmission, wherein the automatic transmission includes an input gear to which a rotational driving force of the input is transmitted, a driven gear meshing with the input gear, and a speed change mechanism that shifts rotation of the driven gear to transmit the shifted rotation to the output, an output rotary member of the rotating electrical machine is drivingly coupled to the input gear, the input gear and the speed change mechanism are separately disposed on two parallel axes, the speed change mechanism is of a planetary gear type and is disposed on a first side in an axial direction, which is one side in the axial direction, with respect to the driven gear, the rotating electrical machine is disposed at such a position that at least a part of the rotating electrical machine overlaps the speed change mechanism as viewed in a radial direction of the rotating electrical machine, and the rotating electrical machine is disposed on the first side in the axial direction with respect to the input gear so as to overlap the input gear or a member that rotates with the input gear as viewed in the axial direction.

According to the above characteristic configuration, the rotating electrical machine is disposed at such a position that at least a part of the rotating electrical machine overlaps the speed change mechanism as viewed in the radial direction of the rotating electrical machine, and the rotating electrical machine is disposed on the first side in the axial direction with respect to the input gear so as to overlap the input gear or the member that rotates with the input gear as viewed in the axial direction. This can restrain an increase in overall device dimensions, which is caused by disposing the rotating electrical machine, both in the axial direction and the direction perpendicular to the axial direction, and can achieve reduction in overall device size.

More specifically, according to the above characteristic configuration, the speed change mechanism disposed on the first side in the axial direction with respect to the driven gear is a planetary gear type speed change mechanism. A configuration can thus be implemented in which no member for transmitting power between the axis on which the input gear is disposed and the axis on which the speed change mechanism is disposed is located on the first side in the axial direction with respect to the driven gear. This allows a space where at least a part of the rotating electrical machine is disposed so as to overlap the speed change mechanism as viewed in the radial direction of the rotating electrical machine to be provided in a region which is located on the first side in the axial direction with respect to the input gear and in which the rotating electrical machine overlaps the input gear or the member that rotates with the input gear as viewed in the axial direction. That is, even in the case where the rotating electrical machine is disposed so as to overlap the input gear or the member that rotates with the input gear as viewed in the axial direction in order to reduce the overall device dimension in the direction perpendicular to the axial direction, the rotating electrical machine can be disposed at such a position that at least a part of the rotating electrical machine overlaps the speed change mechanism as viewed in the radial direction of the rotating electrical machine. Reduction in overall device length in the axial direction can thus be achieved.

As described above, a vehicle drive device capable of restraining an increase in device size which is caused by including a rotating electrical machine can be implemented according to the above characteristic configuration.

### BRIEF DESCRIPTION OF THE DRAWINGS

FIG. 1 is a skeleton diagram of an example of a vehicle drive device according to a first embodiment.

FIG. 2 is a diagram showing an example of the positional relationship of parts of the vehicle drive device according to the first embodiment as viewed in the axial direction.

FIG. 3 is a speed diagram of an automatic transmission according to the first embodiment.

FIG. 4 is an operation table of the automatic transmission according to the first embodiment.

FIG. 5 is a skeleton diagram of another example of the vehicle drive device according to the first embodiment.

FIG. 6 is a skeleton diagram of a vehicle drive device according to a second embodiment.

FIG. 7 is a skeleton diagram of a vehicle drive device according to a third embodiment.

### DETAILED DESCRIPTION OF EMBODIMENTS

### First Embodiment

A first embodiment of a vehicle drive device will be described with reference to the accompanying drawings. In the first embodiment, a common drive gear 13 corresponds to the “drive gear” and an input shaft 90 corresponds to the “input member” or “input.”

As used herein, the expression “drivingly coupled” means the state where two rotary elements are coupled so that they can transmit a driving force therebetween. This concept includes the state where two rotary elements are coupled so as to rotate together and the state where two rotary elements are coupled via one or more transmission members so that they can transmit a driving force therebetween via the one or more transmission members. Such transmission members include various members that transmit rotation at the same speed or at a shifted speed (a shaft, a gear mechanism, a belt, a chain, etc.) and may include engagement devices that selectively transmit rotation and a driving force (a friction engagement device, a meshing engagement device, etc.). In the case where the expression “drivingly coupled” is used for rotary elements of a planetary gear mechanism, a differential gear mechanism, or a mechanism formed by using a planetary gear mechanism or a differential gear mechanism (a first speed change mechanism 41, a second speed change mechanism 42, etc. which will be described below), this expression refers to the state where three or more rotary elements included in the mechanism are drivingly coupled to each other with no other rotary elements interposed.

As used herein, the term “rotating electrical machine” is used as a concept including all of a motor (electric motor), a generator (electric generator), and a motor-generator that functions as both a motor and a generator as necessary. As used herein, regarding arrangement of two members, the expression “overlap each other as viewed in a certain direction” means that when an imaginary line parallel to the viewing direction is moved in each direction perpendicular to the imaginary line, a region where the imaginary line crosses both of the two members is present in at least a part of the range where the imaginary line is moved. For example, the expression “overlap each other as viewed in the radial direction” means that a region where the imaginary line crosses both of the two members is present in at least a part of the range where the imaginary line is moved in the circumferential direction.

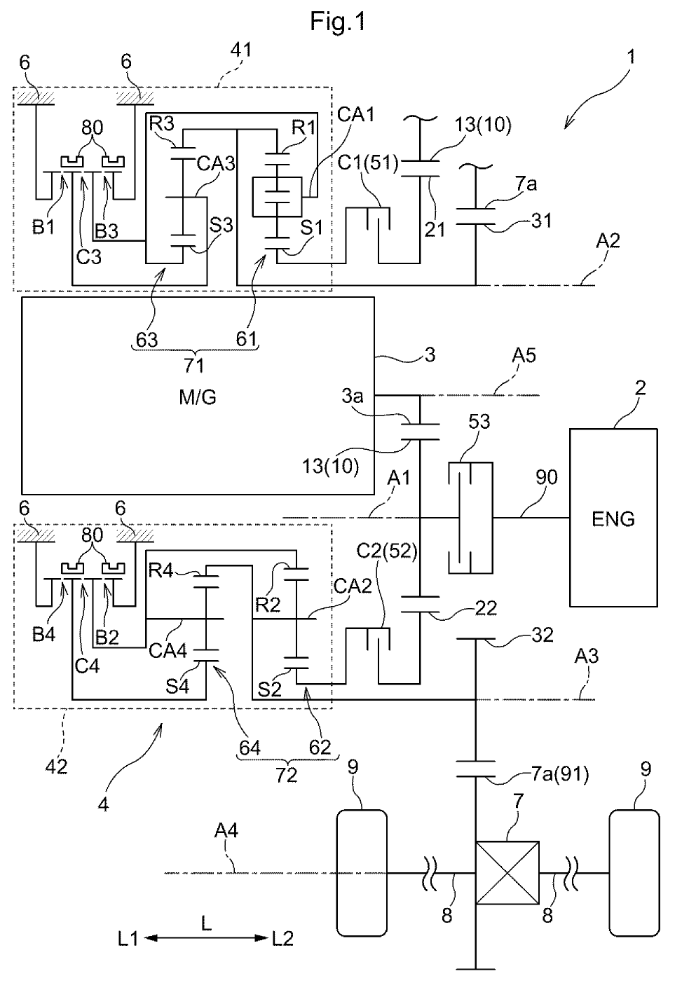

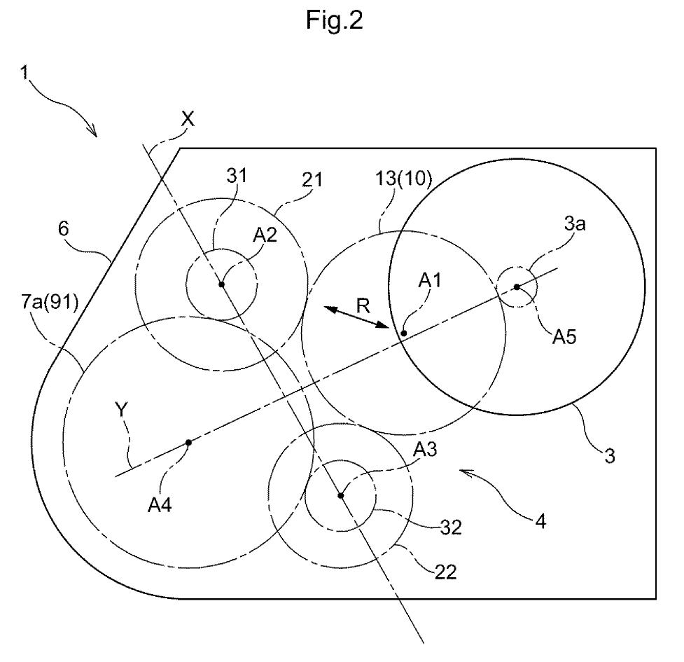

In the following description, the “axial direction L,” the “radial direction R,” and the “circumferential direction” are defined based on a first axis A1 on which an input gear mechanism 10 (input gear) is disposed (namely, based on the input gear mechanism 10) (see FIGS. 1 and 2) unless otherwise specified. The “first side L in the axial direction” refers to one side in the axial direction L, and the “second side L2 in the axial direction” refers to the other side in the axial direction L (the opposite side to the first side L1 in the axial direction). As shown in FIG. 1, the first side L1 in the axial direction is the side on which the first speed change mechanism 41 and the second speed change mechanism 42 are disposed with respect to the input gear mechanism 10 in the axial direction L. As shown in FIG. 1, in the present embodiment, the second side L2 in the axial direction is the side on which an internal combustion engine 2 is disposed with respect to the input gear mechanism 10 in the axial direction L. In the following description, the direction of each member refers to the direction of that member in the assembled vehicle drive device 1. The terms regarding the direction, position, etc. of each member are concepts including the state of that member with variations due to manufacturing tolerance.

As shown in FIG. 1, the vehicle drive device 1 is a drive device (hybrid vehicle drive device) for driving a vehicle (hybrid vehicle) including both the internal combustion engine 2 and a rotating electrical machine 3 as driving force sources for wheels 9. The vehicle drive device 1 transmits torque of at least one of the internal combustion engine 2 and the rotating electrical machine 3 to the wheels 9 to move the vehicle. The vehicle drive device 1 of the present embodiment is configured as a drive device for front engine front drive (FF) vehicles. In FIG. 1, the internal combustion engine 2 is denoted by ENG (Engine) and the rotating electrical machine 3 is denoted by M/G (Motor/Generator).

As shown in FIG. 1, the vehicle drive device 1 includes the input shaft 90 drivingly coupled to the internal combustion engine 2, an output member 91 (output) drivingly coupled to the wheels 9, and an automatic transmission 4. In the present embodiment, the vehicle drive device 1 further includes the rotating electrical machine 3, a differential gear unit 7, and a case 6. At least the automatic transmission 4 is accommodated in the case 6. In the present embodiment, in addition to the automatic transmission 4, the rotating electrical machine 3 and the differential gear unit 7 are accommodated in the case 6.

The internal combustion engine 2 is a motor that is driven by fuel combustion in the engine to output power (e.g., a gasoline engine, a diesel engine, etc.). The input shaft 90 is drivingly coupled to an output shaft of the internal combustion engine 2 (a crankshaft etc.). The input shaft 90 is coupled to the output shaft of the internal combustion engine 2 so as to rotate therewith or is drivingly coupled to the output shaft of the internal combustion engine 2 via other member(s) such as a damper.

The differential gear unit 7 distributes and transmits rotation and torque, which are applied from the automatic transmission 4 side to a differential input gear 7a, to two right and left output shafts 8 (i.e., the two right and left wheels 9). The output shafts 8 are shafts coupling the differential gear unit 7 and the wheels 9 (drive shafts). A rotational driving force of the input shaft 90 is applied to the automatic transmission 4 (the input gear mechanism 10 described below), and the rotational driving force of the input shaft 90 shifted by the automatic transmission 4 is output to the output member 91. The rotational driving force applied from the automatic transmission 4 side to the output member 91 is applied to the differential gear unit 7. In the present embodiment, the differential input gear 7a is used as the output member 91 (functions as the output member 91), and the rotational driving force of the input shaft 90 shifted by the automatic transmission 4 is directly applied to the differential gear unit 7 (the differential input gear 7a).

The rotating electrical machine 3 is used as a driving force source for the wheels 9. An output rotary member 3a of the rotating electrical machine 3 is drivingly coupled to the input gear mechanism 10 described below. In the present embodiment, the output rotary member 3a is an output gear (specifically, an external gear) for outputting torque of the rotating electrical machine 3. Although not shown in the figures, the rotating electrical machine 3 includes a stator fixed to the case 6 and a rotor supported so as to be rotatable with respect to the stator. The output rotary member 3a is coupled to the rotor of the rotating electrical machine 3 so as to rotate therewith. The rotating electrical machine 3 is electrically connected to a power storage device (not shown) such as a battery or a capacitor. The rotating electrical machine 3 is supplied with electric power from the power storage device to perform power running, or supplies electric power generated by the torque of the internal combustion engine 2 or the inertial force of the vehicle to the power storage device to store the electric power therein.

As shown in FIG. 1, the automatic transmission 4 includes the input gear mechanism 10, a first driven gear 21, and the first speed change mechanism 41. The automatic transmission 4 further includes a second driven gear 22, the second speed change mechanism 42, a first engagement device 51, and a second engagement device 52. As described below, in the present embodiment, the input gear mechanism 10 includes the common drive gear 13. As shown in FIGS. 1 and 2, the input gear mechanism 10 and the first speed change mechanism 41 are separately disposed on two parallel axes (a first axis A1 and a second axis A2). The second speed change mechanism 42 is disposed on a different axis (a third axis A3) from the input gear mechanism 10 and the first speed change mechanism 41. That is, the input gear mechanism 10 (the common drive gear 13), the first speed change mechanism 41, and the second speed change mechanism 42 are separately disposed on three parallel axes (the first axis A1, the second axis A2, and the third axis A3). FIG. 2 shows the positional relationship of parts of the vehicle drive device 1 as viewed in the axial direction L, and a reference pitch circle of each gear is shown by an alternate long and short dash line, and the outside diameter of the rotating electrical machine 3 (the outer peripheral surface of the stator in the case where the rotating electrical machine 3 is of an inner rotor type) is shown by a solid line. In the present embodiment, the input gear mechanism 10 (the common drive gear 13), the first speed change mechanism 41, the second speed change mechanism 42, the differential gear unit 7, and the rotating electrical machine 3 are separately disposed on five parallel axes (the first axis A1, the second axis A2, the third axis A3, a fourth axis A4, and a fifth axis A5). Specifically, the input gear mechanism 10 (the common drive gear 13) is disposed on the first axis A1, the first speed change mechanism 41 is disposed on the second axis A2, the second speed change mechanism 42 is disposed on the third axis A3, the differential gear unit 7 is disposed on the fourth axis A4, and the rotating electrical machine 3 is disposed on the fifth axis A5. As described above, in the present embodiment, the rotating electrical machine 3 is disposed on a different axis from the input gear mechanism 10 (the common drive gear 13). As shown in FIG. 2, in the present embodiment, the fourth axis A4 (the central axis of the differential gear unit 7 or the output member 91) is located on one side of a line segment X (an imaginary straight line) connecting the second axis A2 (the central axis of the first speed change mechanism 41) and the third axis A3 (the central axis of the second speed change mechanism 42), and the first axis A1 (the central axis of the input gear mechanism 10 or the input shaft 90) and the fifth axis A5 (the central axis of the rotating electrical machine 3) are located on the other side of the line segment X, as viewed in the axial direction L. That is, the first axis A1 and the fifth axis A5 are located on the opposite side of a plane including both the second axis A2 and the third axis A3 from the fourth axis A4. In the present embodiment, the second axis A2 is located on one side of a line segment Y (an imaginary straight line) connecting the fourth axis A4 and the fifth axis A5, and the third axis A3 is located on the other side of the line segment Y, as viewed in the axial direction L. That is, the third axis A3 is located on the opposite side of a plane including both the fourth axis A4 and the fifth axis A5 from the second axis A2.

In the present embodiment, the first driven gear 21 is disposed on the second axis A2 (i.e., coaxially with the first speed change mechanism 41), and the second driven gear 22 is disposed on the third axis A3 (i.e., coaxially with the second speed change mechanism 42). In the present embodiment, the second driven gear 22 is disposed at such a position that it overlaps the first driven gear 21 as viewed in the radial direction of the first driven gear 21. In this example, the first driven gear 21 and the second driven gear 22 are disposed at the same position in the axial direction L. In the present embodiment, the first engagement device 51 is disposed on the second axis A2 (i.e., coaxially with the first speed change mechanism 41), and the second engagement device 52 is disposed on the third axis A3 (i.e., coaxially with the second speed change mechanism 42). The first engagement device 51 is disposed on the first side L1 in the axial direction with respect to the first driven gear 21 so as to be adjacent to the first driven gear 21, and the second engagement device 52 is disposed on the first side L1 in the axial direction with respect to the second driven gear 22 so as to be adjacent to the second driven gear 22. In the present embodiment, the second engagement device 52 is disposed at such a position that it overlaps the first engagement device 51 as viewed in the radial direction of the first engagement device 51. The first engagement device 51 and the second engagement device 52 are disposed at the same position in the axial direction L. In the present embodiment, the first speed change mechanism 41 is drivingly coupled to the first driven gear 21 via the first engagement device 51 and is disposed on the first side L1 in the axial direction with respect to the first engagement device 51 so as to be adjacent to the first engagement device 51. The second speed change mechanism 42 is drivingly coupled to the second driven gear 22 via the second engagement device 52 and is disposed on the first side L1 in the axial direction with respect to the second engagement device 52 so as to be adjacent to the second engagement device 52. Since the first engagement device 51 and the second engagement device 52 are disposed as described above, the positions in the axial direction L of the ends of the first speed change mechanism 41 and the second speed change mechanism 42 which are located on the second side L2 in the axial direction can be aligned. This makes it easier to increase the extent to which the region in the axial direction L where the first speed change mechanism 41 is disposed and the region in the axial direction L where the second speed change mechanism 42 is disposed overlap each other.

The rotational driving force of the input shaft 90 is transmitted to the input gear mechanism 10. That is, the input gear mechanism 10 is drivingly coupled to the input shaft 90. In the present embodiment, the input gear mechanism 10 includes the common drive gear 13 meshing with both the first driven gear 21 and the second driven gear 22, and the rotational driving force of the input shaft 90 is transmitted to the common drive gear 13. In the present embodiment, the common drive gear 13 is an external gear. As shown in FIG. 1, in the present embodiment, the vehicle drive device 1 includes a third engagement device 53 that couples or decouples the input shaft 90 to or from the input gear mechanism 10 (the common drive gear 13). The third engagement device 53 is provided on a power transmission path between the input shaft 90 and the input gear mechanism 10 (the common drive gear 13). In the present embodiment, the third engagement device 53 is disposed on the second side L2 in the axial direction with respect to the common drive gear 13 and coaxially with the common drive gear 13.

The output rotary member 3a of the rotating electrical machine 3 is drivingly coupled to the common drive gear 13 without the third engagement device 53 interposed therebetween. The output rotary member 3a of the rotating electrical machine is also drivingly coupled to the common drive gear 13 with neither the first engagement device 51 nor the second engagement device 52 interposed therebetween. In the present embodiment, a gear included in the input gear mechanism 10 and meshing with at least one of the first driven gear 21 and the second driven gear 22 serves as a drive gear (in the present embodiment, the common drive gear 13), and the output rotary member 3a of the rotating electrical machine 3 meshes with the drive gear (the common drive gear 13) or is coupled to the drive gear (the common drive gear 13) so as to rotate therewith. In the example shown in FIGS. 1 and 2, the output rotary member 3a of the rotating electrical machine 3 meshes with the common drive gear 13. The output rotary member 3a of the rotating electrical machine 3 meshes with the input gear mechanism 10 (in this example, the common drive gear 13) at a different position in the circumferential direction from the first driven gear 21. In the present embodiment, the output rotary member 3a of the rotating electrical machine 3 meshes with the input gear mechanism 10 (in this example, the common drive gear 13) at a different position in the circumferential direction from the first driven gear 21 and the second driven gear 22. The output rotary member 3a of the rotating electrical machine 3 is thus coupled to a member disposed closer to the input shaft 90 than the first speed change mechanism 41 and the second speed change mechanism 42 are (in the present embodiment, the common drive gear 13) on a power transmission path between the input shaft 90 and the output member 91.

The third engagement device 53 is controlled to be engaged while in an internal combustion engine drive mode in which only torque of the internal combustion engine 2 is transmitted to the wheels 9 to move the vehicle and in a hybrid drive mode in which both torque of the internal combustion engine 2 and torque of the rotating electrical machine 3 are transmitted to the wheels 9 to move the vehicle. The third engagement device 53 is controlled to be disengaged while in an electric drive mode in which only torque of the rotating electrical machine 3 is transmitted to the wheels 9 to move the vehicle. That is, the third engagement device 53 is provided in order to disconnect the internal combustion engine 2 from the wheels 9 while in the electric drive mode. Disconnecting the internal combustion engine 2 from the wheels 9 while in the electric drive mode restrains energy loss resulting from drag loss of the internal combustion engine 2.

The first driven gear 21 is a gear meshing with the input gear mechanism 10. In the present embodiment, the first driven gear 21 meshes with the common drive gear 13 included in the input gear mechanism 10. In the present embodiment, the first driven gear 21 is an external gear. The second driven gear 22 is a gear meshing with the input gear mechanism 10. In the present embodiment, the second driven gear 22 meshes with the common drive gear 13 included in the input gear mechanism 10. As shown in FIG. 2, the first driven gear 21 and the second driven gear 22 mesh with the common drive gear 13 at different positions in the circumferential direction from each other. In the present embodiment, the second driven gear 22 is an external gear.

The first speed change mechanism 41 is a speed change mechanism that shifts rotation of the first driven gear 21 to transmit the shifted rotation to the output member 91. The automatic transmission 4 includes a first output gear 31 meshing with the output member 91 (in the present embodiment, the differential input gear 7a) as a gear for transmitting rotation of the first driven gear 21 shifted by the first speed change mechanism 41 to the output member 91. In the present embodiment, the first output gear 31 is an external gear. The first speed change mechanism 41 shifts rotation of the first driven gear 21 to transmit the shifted rotation to the first output gear 31. The second speed change mechanism 42 is a speed change mechanism that shifts rotation of the second driven gear 22 to transmit the shifted rotation to the output member 91. The automatic transmission 4 includes a second output gear 32 meshing with the output member 91 (in the present embodiment, the differential input gear 7a) as a gear for transmitting rotation of the second driven gear 22 shifted by the second speed change mechanism 42 to the output member 91. The first output gear 31 and the second output gear 32 mesh with the output member 91 at different positions in the circumferential direction about the output member 91 (the circumferential direction about the fourth axis A4) from each other. Both the first output gear 31 and the second output gear 32 thus mesh with the differential input gear 7a that is one gear of the output member 91. In the present embodiment, the second output gear 32 is an external gear. The second speed change mechanism 42 shifts rotation of the second driven gear 22 to transmit the shifted rotation to the second output gear 32. As shown in FIG. 1, in the present embodiment, the first output gear 31 is disposed on the second axis A2 (i.e., coaxially with the first speed change mechanism 41), and the second output gear 32 is disposed on the third axis A3 (i.e., coaxially with the second speed change mechanism 42). In the present embodiment, the first output gear 31 has a smaller diameter than the first driven gear 21. In the present embodiment, the second output gear 32 has a smaller diameter than the second driven gear 22.

The first engagement device 51 is an engagement device that couples or decouples the input shaft 90 to or from the first speed change mechanism 41. The second engagement device 52 is an engagement device that couples or decouples the input shaft 90 to or from the second speed change mechanism 42. The first engagement device 51 and the second engagement device 52 are engagement devices for switching between the first speed change mechanism 41 and the second speed change mechanism 42. Specifically, the first engagement device 51 and the second engagement device 52 are engagement devices for switching the speed change mechanism that shifts rotation of the input shaft 90 to transmit the shifted rotation to the output member 91 between the first speed change mechanism 41 and the second speed change mechanism 42. The speed change mechanism that shifts rotation of the input shaft 90 is switched to the first speed change mechanism 41 by engaging only the first engagement device 51 out of the first engagement device 51 and the second engagement device 52. The speed change mechanism that shifts rotation of the input shaft 90 is switched to the second speed change mechanism 42 by engaging only the second engagement device 52 out of the first engagement device 51 and the second engagement device 52.

In the present embodiment, as described above, the input gear mechanism 10 includes the common drive gear 13 meshing with both the first driven gear 21 and the second driven gear 22. The first engagement device 51 and the second engagement device 52 are therefore provided on a power transmission path between the common drive gear 13 and the speed change mechanisms (41, 42). Specifically, the first engagement device 51 is provided on a power transmission path between the first driven gear 21 and the first speed change mechanism 41 (in the present embodiment, a first sun gear S1 described below) and couples or decouples the first driven gear 21 to or from the first speed change mechanism 41. The second engagement device 52 is provided on a power transmission path between the second driven gear 22 and the second speed change mechanism 42 (in the present embodiment, a second sun gear S2 described below) and couples or decouples the second driven gear 22 to or from the second speed change mechanism 42.

In view of vehicle mountability of the vehicle drive device 1, it is preferable that the overall device size be as small as possible. It is preferable that a vehicle drive device that is disposed adjacent to the internal combustion engine 2 in the lateral direction of a vehicle like, e.g., a drive device for FF vehicles be small especially in the axial direction L. In this regard, the vehicle drive device 1 of the present embodiment can restrain an increase in device size while including both the automatic transmission 4 including two speed change mechanisms (41, 42) and two engagement devices (51, 52) for switching between the two speed change mechanisms (41, 42) and the rotating electrical machine 3. This will be described below.

As shown in FIG. 1, the first speed change mechanism 41 is of a planetary gear type and is disposed on the first side L1 in the axial direction with respect to the first driven gear 21. The second speed change mechanism 42 is of a planetary gear type and is disposed on the first side L1 in the axial direction with respect to the second driven gear 22. As used herein, the planetary gear type speed change mechanism refers to a speed change mechanism which is formed by using a single planetary gear mechanism or a plurality of planetary gear mechanisms and in which the speed ratio is changed by controlling the differential state of each planetary gear mechanism by a clutch or a brake. The first speed change mechanism 41 and the second speed change mechanism 42 do not have a parallel axis gear type power transmission mechanism. The parallel axis gear type power transmission mechanism is a mechanism in which power transmission between or among a plurality of parallel axes (axes whose positions are fixed) is carried out by meshing of gears disposed on the axes. That is, each of the first speed change mechanism 41 and the second speed change mechanism 42 which are planetary gear type speed change mechanisms includes an engagement device and a planetary gear mechanism(s). In the first speed change mechanism 41 and the second speed change mechanism 42 which are planetary gear type speed change mechanisms, the speed ratio is attained (or changed) by only the planetary gear mechanism(s) by switching between engagement and disengagement of the engagement device (switching of the engagement state of the engagement device). In the present embodiment, the first driven gear 21 and the second driven gear 22 are disposed at the same position in the axial direction L. In the present embodiment, the first speed change mechanism 41 and the second speed change mechanism 42 are disposed so that the region in the axial direction L where the first speed change mechanism 41 is disposed and the region in the axial direction L where the second speed change mechanism 42 is disposed overlap each other. That is, the second speed change mechanism 42 is disposed at such a position that it overlaps the first speed change mechanism 41 as viewed in the radial direction of the first speed change mechanism 41. In the present embodiment, the first speed change mechanism 41 and the second speed change mechanism 42 are disposed so as not to overlap each other as viewed in the axial direction L.

The rotating electrical machine 3 is disposed on the first side L1 in the axial direction with respect to the input gear mechanism 10 (the common drive gear 13) so as to overlap the input gear mechanism 10 (the common drive gear 13) or a member(s) that rotates with the input gear mechanism 10 as viewed in the axial direction L. The member(s) that rotates with the input gear mechanism 10 includes a member that is disposed coaxially with the input gear mechanism 10 (in this example, on the first axis A1) and that always rotates with the input gear mechanism 10. In the present embodiment, the third engagement device 53 (specifically, an output-side engagement member of the third engagement device 53) corresponds to such a member. The member(s) that rotates with the input gear mechanism 10 may include a member that is disposed coaxially with the input gear mechanism 10 and that rotates with the input gear mechanism 10 with the member and the input gear mechanism 10 being kept coupled together. In the present embodiment, an input-side engagement member of the third engagement device 53 and the input shaft 90, which rotate with the input gear mechanism 10 with the third engagement device 53 being directly coupled to the input gear mechanism 10, correspond to such members. In the present embodiment, the rotating electrical machine 3 is disposed so as to overlap the input gear mechanism 10 (the common drive gear 13) as viewed in the axial direction L (see FIG. 2). In the present embodiment, the rotating electrical machine 3 is disposed so as to overlap the member(s) that rotates with the input gear mechanism 10 as viewed in the axial direction L. Specifically, the rotating electrical machine 3 is disposed so as to overlap the third engagement device 53 and the input shaft 90 as viewed in the axial direction L. In the present embodiment, the rotating electrical machine 3 is thus disposed so as to overlap both the input gear mechanism 10 and the member(s) that rotates with the input gear mechanism 10 as viewed in the axial direction L. As shown in FIG. 2, in the present embodiment, the rotating electrical machine 3 is disposed so as to overlap the axis of the input gear mechanism 10 (the first axis A1) as viewed in the axial direction L. The rotating electrical machine 3 is disposed at such a position that at least a part of the rotating electrical machine 3 overlaps the first speed change mechanism 41 as viewed in the radial direction of the rotating electrical machine 3. In the present embodiment, the rotating electrical machine 3 is disposed at such a position that at least a part of the rotating electrical machine 3 overlaps each of the first speed change mechanism 41 and the second speed change mechanism 42 as viewed in the radial direction of the rotating electrical machine 3. This can restrain an increase in overall device dimensions, which is caused by disposing the rotating electrical machine 3, both in the axial direction L and a direction perpendicular to the axial direction L, and can achieve reduction in overall device size, as described below.

As described above, the first speed change mechanism 41 disposed on the first side L1 in the axial direction with respect to the first driven gear 21 is a planetary gear type speed change mechanism. A configuration can thus be implemented in which no member for transmitting power between the first axis A1 on which the input gear mechanism 10 is disposed and the second axis A2 on which the first speed change mechanism 41 is disposed is located on the first side L1 in the axial direction with respect to the first driven gear 21. Similarly, the second speed change mechanism 42 disposed on the first side L1 in the axial direction with respect to the second driven gear 22 is a planetary gear type speed change mechanism. A configuration can thus be implemented in which no member for transmitting power between the first axis A1 on which the input gear mechanism 10 is disposed and the third axis A3 on which the second speed change mechanism 42 is disposed is located on the first side L1 in the axial direction with respect to the second driven gear 22. This allows a space where at least a part of the rotating electrical machine 3 is disposed so as to overlap each of the first speed change mechanism 41 and the second speed change mechanism 42 as viewed in the radial direction of the rotating electrical machine 3 to be provided in a region which is located on the first side L in the axial direction with respect to the input gear mechanism 10 and in which the rotating electrical machine 3 overlaps the input gear mechanism 10 or the member(s) that rotates with the input gear mechanism 10 as viewed in the axial direction L. That is, in order to reduce the overall device dimension in the direction perpendicular to the axial direction L, the rotating electrical machine 3 is disposed so as to overlap the input gear mechanism 10 (the common drive gear 13) or the member(s) that rotates with the input gear mechanism 10 as viewed in the axial direction L. The rotating electrical machine 3 is also disposed at such a position that at least a part of the rotating electrical machine 3 overlaps each of the first speed change mechanism 41 and the second speed change mechanism 42 as viewed in the radial direction of the rotating electrical machine 3, whereby reduction in overall device length in the axial direction L can be achieved. In the present embodiment, at least a part of the rotating electrical machine 3 is disposed in the region in the axial direction L where both the first speed change mechanism 41 and the second speed change mechanism 42 are disposed. The rotating electrical machine 3 is disposed so as not to overlap the first speed change mechanism 41 and the second speed change mechanism 42 as viewed in the axial direction L.

In the present embodiment, no rotary member disposed coaxially with the input gear mechanism 10 (i.e., no rotary member disposed on the first axis A1) is present on the first side L1 in the axial direction with respect to the input gear mechanism 10 (the common drive gear 13). In the present embodiment, no parallel axis gear type speed change mechanism capable of changing the speed ratio is provided on the first side L1 in the axial direction with respect to the input gear mechanism 10 (the common drive gear 13). As used herein, the parallel axis gear type speed change mechanism capable of changing the speed ratio refers to a speed change mechanism which is formed by using a parallel axis gear type power transmission mechanism described above and in which the speed ratio is changed by switching the combination of gears to be coupled with shafts between or among the combinations of a plurality of gears disposed on each shaft. In the present embodiment, no parallel axis gear type speed change mechanism (power transmission mechanism) with a fixed speed ratio such as a counter gear mechanism is provided on the first side L1 in the axial direction with respect to the input gear mechanism 10 (the common drive gear 13), either.

In the present embodiment, as shown in FIG. 1, the output rotary member 3a of the rotating electrical machine 3 has a smaller diameter than the drive gear that is provided in the input gear mechanism 10 and is configured to mesh with the output rotary member 3a (in the present embodiment, the common drive gear 13). In the present embodiment, rotation of the rotating electrical machine 3 is therefore reduced in speed and transmitted to the input gear mechanism 10 (the common drive gear 13). A smaller rotating electrical machine 3 can thus be used to obtain the same output torque, as compared to the case where rotation of the rotating electrical machine 3 is transmitted at the same speed or at an increased speed to the input gear mechanism 10 (the common drive gear 13). Reduction in overall device size can be achieved in this regard as well.

Moreover, in the present embodiment, as shown in FIG. 1, the first output gear 31 is disposed on the second side L2 in the axial direction with respect to the first speed change mechanism 41, and the second output gear 32 is disposed on the second side L2 in the axial direction with respect to the second speed change mechanism 42. In the present embodiment, both the first output gear 31 and the second output gear 32 are disposed so as to overlap the third engagement device 53 as viewed in the radial direction R (in the present embodiment, the radial direction of the common drive gear 13). In the present embodiment, the second output gear 32 is disposed at such a position that it overlaps the first output gear 31 as viewed in the radial direction of the first output gear 31. In this example, the first output gear 31 and the second output gear 32 are disposed at the same position in the axial direction L. As shown in FIG. 1, in the present embodiment, the first output gear 31, the first driven gear 21, the first engagement device 51, and the first speed change mechanism 41 are disposed on the second axis A2 in this order from the second side L2 in the axial direction, and the second output gear 32, the second driven gear 22, the second engagement device 52, and the second speed change mechanism 42 are disposed on the third axis A3 in this order from the second side L2 in the axial direction. That is, the output gear (31, 32), the driven gear (21, 22), the engagement device (51, 52), and the speed change mechanism (41, 42) are disposed in this order from the second side L2 in the axial direction.

The configurations of the first speed change mechanism 41 and the second speed change mechanism 42 according to the present embodiment will be specifically described below. The automatic transmission 4 is a stepped automatic transmission capable of establishing a plurality of shift speeds having different speed ratios. In the present embodiment, as shown in FIG. 4, the automatic transmission 4 is configured to be able to establish six forward shift speeds having different speed ratios (a first speed 1st, a second speed 2nd, a third speed 3rd, a fourth speed 4th, a fifth speed 5th, and a sixth speed 6th). The speed ratios of these forward shift speeds decrease stepwise from the first speed toward the sixth speed (i.e., toward the higher speed). As used herein, the “speed ratio” is the ratio of the rotational speed of the input gear mechanism 10 (the common drive gear 13) to the rotational speed of the output member 91.

In the present embodiment, the first speed change mechanism 41 establishes odd speeds out of the plurality of forward shift speeds, and the second speed change mechanism 42 establishes even speeds out of the plurality of forward shift speeds. As used herein, the odd speeds refer to the odd-numbered shift speeds in the case where the plurality of forward shift speeds are arranged in descending order of the speed ratio (in the present embodiment, the first speed 1st, the third speed 3rd, and the fifth speed 5th), and the even speeds refer to the even-numbered shift speeds in the case where the plurality of forward shift speeds are arranged in descending order of the speed ratio (in the present embodiment, the second speed 2nd, the fourth speed 4th, and the sixth speed 6th). Accordingly, as shown in FIG. 4, when the automatic transmission 4 establishes an odd speed, a first clutch C1 serving as the first engagement device 51 is engaged and a second clutch C2 serving as the second engagement device 52 is disengaged, whereby rotation of the input gear mechanism 10 (the common drive gear 13) is applied to the first speed change mechanism 41. When the automatic transmission 4 establishes an even speed, the first clutch C1 is disengaged and the second clutch C2 is engaged, whereby rotation of the input gear mechanism 10 (the common drive gear 13) is applied to the second speed change mechanism 42. In FIG. 4, “0” indicates that the engagement device (clutch or brake) is engaged, and “blank” indicates that the engagement device is disengaged. In the present embodiment, the automatic transmission 4 is not configured to be able to establish a reverse shift speed. When the vehicle moves backward, the rotating electrical machine 3 is rotated in the opposite direction to that in which the rotating electrical machine 3 is rotated when the vehicle moves forward, with any of the forward shift speeds (e.g., the first speed 1st) being established.

As described above, the third engagement device 53 is disengaged while in the electric drive mode. In the present embodiment, the output rotary member 3a of the rotating electrical machine 3 is coupled to a member disposed closer to the input shaft 90 than the first engagement device 51 (the first clutch C1) and the second engagement device 52 (the second clutch C2) are (specifically, the common drive gear 13) on the power transmission path between the input shaft 90 and the output member 91. Accordingly, by engaging the first engagement device 51, rotation of the rotating electrical machine 3 can be shifted by the first speed change mechanism 41 and transmitted to the output member 91. By engaging the second engagement device 52, rotation of the rotating electrical machine 3 can be shifted by the second speed change mechanism 42 and transmitted to the output member 91. That is, the electric drive mode can be implemented at both an odd speed that is established by the first speed change mechanism 41 and an even speed that is established by the second speed change mechanism 42. Moreover, the hybrid drive mode can be attained (i.e., assist torque can be generated by the rotating electrical machine 3) and electric power can be generated by the rotating electrical machine 3 (i.e., regenerative torque can be generated by the rotating electrical machine 3) at both an odd speed that is established by the first speed change mechanism 41 and an even speed that is established by the second speed change mechanism 42.

Although not described in detail, the vehicle drive device 1 according to the present embodiment can be used as a drive device for plug-in hybrid vehicles whose power storage device for supplying electric power to the rotating electrical machine 3 can be recharged by an external power supply such as a domestic power supply. That is, in the present embodiment, even in the case where the shift speed having the lowest speed ratio (in the present embodiment, the sixth speed 6th) has been established by the automatic transmission 4 (that is, in the case where the vehicle speed is high enough that the shift speed having the lowest speed ratio is selected), the magnitude of output torque of the rotating electrical machine 3 has been set to such a value that torque with a magnitude required for the output member 91 can be transmitted from the rotating electrical machine 3.

In the present embodiment, the first speed change mechanism 41 includes two planetary gear mechanisms. That is, the first speed change mechanism 41 includes a first gear mechanism 71 formed by using a planetary gear mechanism (in this example, two planetary gear mechanisms). Each of the two planetary gear mechanisms has three rotary elements, and these two sets of three rotary elements are coupled in pairs so that the rotary elements of each pair rotate together, thereby forming a planetary gear unit including four rotary elements as a whole. Specifically, as shown in FIG. 1, the first speed change mechanism 41 includes a first planetary gear mechanism 61 and a third planetary gear mechanism 63. The third planetary gear mechanism 63 is disposed on the first side L1 in the axial direction with respect to the first planetary gear mechanism 61 so as to be adjacent to the first planetary gear mechanism 61. The first planetary gear mechanism 61 is a double-pinion type planetary gear mechanism, and the third planetary gear mechanism 63 is a single-pinion type planetary gear mechanism. A ring gear of the first planetary gear mechanism 61 (a first ring gear R1) and a ring gear of the third planetary gear mechanism 63 (a third ring gear R3) are coupled so as to rotate together, and a carrier of the first planetary gear mechanism 61 (a first carrier CA1) and a sun gear of the third planetary gear mechanism 63 (a third sun gear S3) are coupled so as to rotate together. A sun gear of the first planetary gear mechanism 61 (the first sun gear S1) is coupled to the first driven gear 21 via the first engagement device 51 (the first clutch C1), and the first ring gear R1 and the third ring gear R3 are coupled to the first output gear 31 so as to rotate therewith. The first speed change mechanism 41 includes a first brake B1 that selectively holds a carrier of the third planetary gear mechanism 63 (a third carrier CA3) stationary with respect to the case 6, a third brake B3 that selectively holds the first carrier CA1 and the third sun gear S3 stationary with respect to the case 6, and a third clutch C3 that selectively couples the third carrier CA3 to the first carrier CA1 and the third sun gear S3. In the present embodiment, all of the first brake B1, the third brake B3, and the third clutch C3 are disposed on the first side L1 in the axial direction with respect to the first gear mechanism 71.

In the present embodiment, the second speed change mechanism 42 includes two planetary gear mechanisms. That is, the second speed change mechanism 42 includes a second gear mechanism 72 formed by using a planetary gear mechanism (in this example, two planetary gear mechanisms). Each of the two planetary gear mechanisms has three rotary elements, and these two sets of three rotary elements are coupled in pairs so that the rotary elements of each pair rotate together, thereby forming a planetary gear unit including four rotary elements as a whole. Specifically, as shown in FIG. 1, the second speed change mechanism 42 includes a second planetary gear mechanism 62 and a fourth planetary gear mechanism 64. The fourth planetary gear mechanism 64 is disposed on the first side L1 in the axial direction with respect to the second planetary gear mechanism 62 so as to be adjacent to the second planetary gear mechanism 62. The second planetary gear mechanism 62 is a single-pinion type planetary gear mechanism, and the fourth planetary gear mechanism 64 is also a single-pinion type planetary gear mechanism. That is, the second speed change mechanism 42 has a different configuration from the first speed change mechanism 41. A ring gear of the second planetary gear mechanism 62 (a second ring gear R2) and a carrier of the fourth planetary gear mechanism 64 (a fourth carrier CA4) are coupled so as to rotate together, and a carrier of the second planetary gear mechanism 62 (a second carrier CA2) and a ring gear of the fourth planetary gear mechanism 64 (a fourth ring gear R4) are coupled so as to rotate together. A sun gear of the second planetary gear mechanism 62 (the second sun gear S2) is coupled to the second driven gear 22 via the second engagement device 52 (the second clutch C2), and the second carrier CA2 and the fourth ring gear R4 are coupled to the second output gear 32 so as to rotate therewith. The second speed change mechanism 42 includes a second brake B2 that selectively holds the second ring gear R2 and the fourth carrier CA4 stationary with respect to the case 6, a fourth brake B4 that selectively holds a sun gear of the fourth planetary gear mechanism 64 (a fourth sun gear S4) stationary with respect to the case 6, and a fourth clutch C4 that selectively couples the second ring gear R2 and the fourth carrier CA4 to the fourth sun gear S4. In the present embodiment, all of the second brake B2, the fourth brake B4, and the fourth clutch C4 are disposed on the first side L1 in the axial direction with respect to the second gear mechanism 72.

As described above, in the present embodiment, the first speed change mechanism 41 includes two planetary gear mechanisms (specifically, the first planetary gear mechanism 61 and the third planetary gear mechanism 63) arranged next to each other in the axial direction L, and the second speed change mechanism 42 includes two planetary gear mechanisms (specifically, the second planetary gear mechanism 62 and the fourth planet gear mechanism 64) arranged next to each other in the axial direction L. That is, in the present embodiment, the number of planetary gear mechanisms of the first speed change mechanism 41 which are arranged in the axial direction L is the same as that of planetary gear mechanisms of the second speed change mechanism 42 which are arranged in the axial direction L. Such a configuration allows the first speed change mechanism 41 and the second speed change mechanism 42 to have the same or about the same length in the axial direction L. As a result, the entire first speed change mechanism 41 or a large part of the first speed change mechanism 41 and the entire second speed change mechanism 42 or a large part of the second speed change mechanism 42 can be disposed in the same region in the axial direction L, whereby reduction in overall device size in the axial direction L can be achieved.

The first speed change mechanism 41 includes the first gear mechanism 71 and first shift engagement devices (in this example, the first brake B1, the third brake B3, and the third clutch C3) that are disposed on the first side L1 in the axial direction with respect to the first gear mechanism 71 and control the differential state of the first gear mechanism 71. The second speed change mechanism 42 includes the second gear mechanism 72 and second shift engagement devices (in this example, the second brake B2, the fourth brake B4, and the fourth clutch C4) that are disposed on the first side L1 in the axial direction with respect to the second gear mechanism 72 and control the differential state of the second gear mechanism 72. In the present embodiment, the first shift engagement devices (B1, B3, C3) are disposed at such positions that they overlap the second shift engagement devices (B2, B4, C4) as viewed in the radial direction of the second speed change mechanism 42. As used herein, the first shift engagement devices overlapping the second shift engagement devices means the first shift engagement devices are disposed at such positions that at least one of the first shift engagement devices overlaps at least one of the second shift engagement devices as viewed in the radial direction of the second speed change mechanism 42. In this example, the first brake B1 and the fourth brake B4 are disposed at the same position in the axial direction L, the third clutch C3 and the fourth clutch C4 are disposed at the same position in the axial direction L, and the third brake B3 and the second brake B2 are disposed at the same position in the axial direction L. Such a configuration also allows the first speed change mechanism 41 and the second speed change mechanism 42 to have the same or about the same length in the axial direction L. The first shift engagement devices may be disposed at such positions that none of the first shift engagement devices overlap any of the second shift engagement devices as viewed in the radial direction of the second speed change mechanism 42.

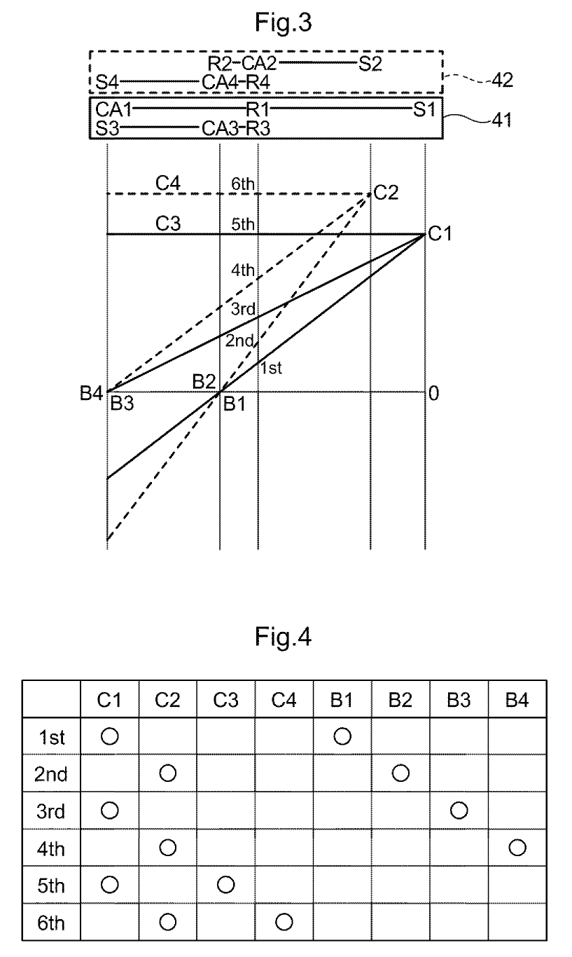

FIG. 3 shows speed diagrams (nomograms) of the first speed change mechanism 41 and the second speed change mechanism 42 which are configured as described above. In FIG. 3, the ordinates correspond to the rotational speed of each rotary element shown in the upper part of FIG. 3 (the four rotary elements of the first speed change mechanism 41 and the four rotary elements of the second speed change mechanism 42), and “0” indicates that the rotational speed is zero. The rotational speed is positive in the region above “0,” and the rotational speed is negative in the region below “0.” Each forward shift speed is established by controlling the engagement state of each engagement device (C1, C2, C3, C4, B1, B2, B3, B4) as shown in FIG. 4. Although not shown in the figure, a parking range is attained by engaging all of the four brakes (B1, B2, B3, B4) or engaging two brakes (B1 and B3 or B2 and B4) out of the four brakes (B1, B2, B3, B4). A neutral range is attained by disengaging all of the engagement devices (C1, C2, C3, C4, B1, B2, B3, B4).

In FIG. 3, the speed diagrams of the first speed change mechanism 41 and the second speed change mechanism 42 are shown superimposed on each other so that the rotational speeds of the input gear mechanism 10 (the common drive gear 13) in the speed diagrams are equal to each other. As shown in FIG. 2, in the present embodiment, the second driven gear 22 has a smaller diameter than the first driven gear 21. Accordingly, in the case where a first speed ratio refers to the speed ratio between the input gear mechanism 10 (the common drive gear 13) and the first speed change mechanism 41 (specifically, the rotary element in the first speed change mechanism 41 which is drivingly coupled to the input gear mechanism 10) and a second speed ratio refers to the speed ratio between the input gear mechanism 10 (the common drive gear 13) and the second speed change mechanism 42 (specifically, the rotary element in the second speed change mechanism 42 which is drivingly coupled to the input gear mechanism 10), the first speed ratio and the second speed ratio have different values from each other in the present embodiment. Specifically, in the case where the first speed ratio refers to the ratio of the rotational speed of the input gear mechanism 10 (the common drive gear 13) to the rotational speed of the first driven gear 21 and the second speed ratio refers to the ratio of the rotational speed of the input gear mechanism 10 (the common drive gear 13) to the rotational speed of the second driven gear 22, the second speed ratio is lower than the first speed ratio. As a result, as shown in FIG. 3, the rotational speed of the second sun gear S2 with the second clutch C2 being engaged (the rotational speed of the second driven gear 22) is higher than the rotational speed of the first sun gear S1 with the first clutch C1 being engaged (the rotational speed of the first driven gear 21).

As shown in FIG. 2, in the present embodiment, the first output gear 31 and the second output gear 32 have the same diameter. Accordingly, in the case where a third speed ratio refers to the speed ratio between the first speed change mechanism 41 (specifically, the rotary element in the first speed change mechanism 41 which is drivingly coupled to the output member 91) and the output member 91 and a fourth speed ratio refers to the speed ratio between the second speed change mechanism 42 (specifically, the rotary element in the second speed change mechanism 42 which is drivingly coupled to the output member 91) and the output member 91, the third speed ratio and the fourth speed ratio have the same value in the present embodiment. In the present embodiment, the ratio of the rotational speed of the first output gear 31 to the rotational speed of the output member 91 (the third speed ratio) is thus the same as the ratio of the rotational speed of the second output gear 32 to the rotational speed of the output member 91 (the fourth speed ratio). Unlike such a configuration, in the case where the third speed ratio is different from the fourth speed ratio, namely in the case where the first output gear 31 and the second output gear 32 are gears of different diameters from each other, not one kind but two kinds of gears need to be used as the first output gear 31 and the second output gear 32 which are required to transfer relatively larger torque than the first driven gear 21 and the second driven gear 22 as the rotational speed is reduced by the automatic transmission 4. This may cause an increase in manufacturing cost because, for example, as the number of kinds of gears increases, the number of items that need to be verified in order to ensure that the first output gear 31 and the second output gear 32 have required strength is increased. On the other hand, in the present embodiment, the first output gear 31 and the second output gear 32 are gears of the same diameter. Accordingly, the same kind of gears can be used as the first output gear 31 and the second output gear 32, whereby the manufacturing cost can be reduced. Since the first driven gear 21 and the second driven gear 22 are gears of different diameters from each other, two kinds of gears need to be used as the first driven gear 21 and the second driven gear 22. However, since the first driven gear 21 and the second driven gear 22 are required to transmit smaller torque than the first output gear 31 and the second output gear 32, it is easier to ensure that the first driven gear 21 and the second driven gear 22 have required strength. The manufacturing cost can therefore be reduced as compared to the case where two kinds of gears are used as the first output gear 31 and the second output gear 32. Since the third speed ratio and the fourth speed ratio have the same value as described above, the speed ratio between the input gear mechanism 10 and the output member 91 can be changed by changing the gear ratios between the first and second output gears 31, 32 and the differential input gear 7a without changing the speed ratio step in each combination of adjacent shift speeds (the ratio of speed ratio between adjacent shift speeds). It is therefore easier to change the speed ratio between the input gear mechanism 10 and the output member 91 according to the type of vehicle on which the vehicle drive device 1 is to be mounted etc. In a configuration in which the first speed ratio and the second speed ratio have the same value, the speed ratio between the input gear mechanism 10 and the output member 91 can be changed by changing the gear ratios between the first and second driven gears 21, 22 and the input gear mechanism 10 without changing the speed ratio step in each combination of adjacent shift speeds.

In the present embodiment, as shown in FIG. 3, both the minimum speed ratio that is attained by the first speed change mechanism 41 and the minimum speed ratio that is attained by the second speed change mechanism 42 are 1. As used herein, the speed ratio that is attained by the first speed change mechanism 41 refers to the ratio of the rotational speed of the first sun gear S1 (the rotational speed of the first driven gear 21) to the rotational speed of the first ring gear R1 and the third ring gear R3 (the rotational speed of the first output gear 31). As used herein, the speed ratio that is attained by the second speed change mechanism 42 refers to the ratio of the rotational speed of the second sun gear S2 (the rotational speed of the second driven gear 22) to the rotational speed of the second carrier CA2 and the fourth ring gear R4 (the rotational speed of the second output gear 32).

In the present embodiment, when the automatic transmission 4 (the first speed change mechanism 41) establishes the fifth speed 5th, the speed ratio that is attained by the first speed change mechanism 41 is the minimum speed ratio, namely 1. In this state, all of the rotary elements of the first speed change mechanism 41 (in the present embodiment, the four rotary elements) rotate together at the same speed. That is, differential rotation of the planetary gear mechanisms that form the first speed change mechanism 41 is prohibited, whereby the first speed change mechanism 41 achieves maximum power transmission efficiency. In the present embodiment, when the automatic transmission 4 (the second speed change mechanism 42) establishes the sixth speed 6th, the speed ratio that is attained by the second speed change mechanism 42 is the minimum speed ratio, namely 1. In this state, all of the rotary elements of the second speed change mechanism 42 (in the present embodiment, the four rotary elements) rotate together at the same speed. That is, differential rotation of the planetary gear mechanisms that form the second speed change mechanism 42 is prohibited, whereby the second speed change mechanism 42 achieves maximum power transmission efficiency. The minimum speed ratios that are attained by the first speed change mechanism 41 and the second speed change mechanism 42 are typically attained for a longer period of time while the vehicle is moving than the other speed ratios that are attained by the first speed change mechanism 41 and the second speed change mechanism 42, and thus greatly affect energy efficiency of the vehicle drive device 1. As described above, for both the first speed change mechanism 41 and the second speed change mechanism 42, the minimum speed ratio is 1 at which the speed change mechanism (41, 42) has maximum power transmission efficiency. Accordingly, high power transmission efficiency between the input gear mechanism 10 (the common drive gear 13) and the output member 91 can be achieved with the minimum speed ratio being attained, and the energy efficiency of the vehicle drive device 1 can be improved.

In the present embodiment, as described above, the first speed ratio and the second speed ratio have different values from each other, and the third speed ratio and the fourth speed ratio have the same value. Accordingly, in the present embodiment, the product of the first speed ratio and the third speed ratio and the product of the second speed ratio and the fourth speed ratio have different values from each other. As a result, even when both the minimum speed ratio that is attained by the first speed change mechanism 41 and the minimum speed ratio that is attained by the second speed change mechanism 42 are 1, the speed ratio between the input gear mechanism 10 (the common drive gear 13) and the output member 91 can be varied between when the minimum speed ratio has been attained by the first speed change mechanism 41 (in the present embodiment, when the fifth speed 5th has been established) and when the minimum speed ratio has been attained by the second speed change mechanism 42 (in the present embodiment, when the sixth speed 6th has been established). When deriving the product of the first speed ratio and the third speed ratio and the product of the second speed ratio and the fourth speed ratio, each of the first speed ratio, the second speed ratio, the third speed ratio, and the fourth speed ratio is the ratio of the rotational speed of a member disposed closer to the input gear mechanism 10 on a power transmission path to the rotational speed of a member disposed closer to the output member 91 on the power transmission path, or each of the first speed ratio, the second speed ratio, the third speed ratio, and the fourth speed ratio is the ratio of the rotational speed of a member disposed closer to the output member 91 on a power transmission path to the rotational speed of a member disposed closer to the input gear mechanism 10 on the power transmission path.

In the present embodiment, both the first engagement device 51 (the first clutch C1) and the second engagement device 52 (the second clutch C2) are friction engagement devices. In the present embodiment, the third engagement device 53 is also a friction engagement device. As used herein, the friction engagement device refers to an engagement device that transmits torque by a frictional force generated between engagement members engaging with each other. For example, hydraulically driven friction engagement devices or electromagnetically driven friction engagement devices can be used as the first engagement device 51, the second engagement device 52, and the third engagement device 53. Since both the first engagement device 51 and the second engagement device 52 are friction engagement devices, gear shifting between an odd speed and an even speed can be performed while power transmission to the output member 91 is maintained. For example, when an odd speed has been established by the automatic transmission, the first engagement device 51 is in an engaged state and the second engagement device 52 is in a disengaged state. In this state, rotation of the input gear mechanism 10 (the common drive gear 13) is shifted by the first speed change mechanism 41 having established the odd speed, and the shifted rotation is transmitted to the output member 91. The wheels 9 are thus driven by output torque of at least one of the internal combustion engine 2 and the rotating electrical machine 3. Moreover, the second speed change mechanism 42 establishes an even speed predicted to be established by gear shifting out of two even speeds adjacent to the odd speed that has been established by the first speed change mechanism 41, and goes into a standby state, ready for upshifting or downshifting.

When gear shifting is performed in this state to establish the even speed, the first engagement device 51 is disengaged and the second engagement device 52 is engaged. Since both the first engagement device 51 and the second engagement device 52 are friction engagement devices, the second engagement device 52 can be engaged with the first engagement device 51 being controlled to a slip-engaged state. That is, the second engagement device 52 is engaged with output torque of at least one of the internal combustion engine 2 and the rotating electrical machine 3 being transmitted to the output member 91 and the wheels 9 via the first engagement device 51 in a slip-engaged state. Gear shifting from the odd speed to the even speed can thus be performed while power transmission to the output member 91 is maintained. Similarly, when performing gear shifting from an even speed to an odd speed, the first engagement device 51 is engaged with output torque of at least one of the internal combustion engine 2 and the rotating electrical machine 3 being transmitted to the output member 91 and the wheels 9 via the second engagement device 52 in a slip-engaged state. Gear shifting from the even speed to the odd speed can thus be performed while power transmission to the output member 91 is maintained.

In the example shown in FIG. 1, all of the engagement devices included in the first speed change mechanism 41 and the second speed change mechanism 42 (specifically, the third clutch C3, the fourth clutch C4, the first brake B1, the second brake B2, the third brake B3, and the fourth brake B4) are meshing engagement devices (dog clutches). That is, in the example shown in FIG. 1, both shifting between shift speeds by the first speed change mechanism 41 and shifting between shift speeds by the second speed change mechanism 42 are performed by switching the engagement state of the meshing engagement devices. For example, the use of meshing engagement devices that are driven by electric actuators as these engagement devices can significantly reduce the number of hydraulically operated parts. Although not described in detail, the meshing engagement device is provided with a synchro mechanism (synchronization mechanism) that synchronizes rotation of two rotary members to be engaged.

As shown in FIG. 1, the meshing engagement device includes a sleeve 80 that moves in the axial direction L, and the engagement state of the meshing engagement device is switched by switching the position of the sleeve 80 in the axial direction L. In the example shown in FIG. 1, the third clutch C3 and first brake B1 are configured as meshing engagement devices having a common sleeve 80. The engagement state of these meshing engagement devices is switched among the state where only the third clutch C3 out of the third clutch C3 and the first brake B1 is engaged, the state where only the first brake B1 out of the third clutch C3 and the first brake B1 is engaged, and the state where both the third clutch C3 and the first brake B are engaged, according to the position of the sleeve 80 in the axial direction L. In the example shown in FIG. 1, the fourth clutch C4 and the fourth brake B4 are configured as meshing engagement devices having a common sleeve 80. The engagement state of these meshing engagement devices is switched among the state where only the fourth clutch C4 out of the fourth clutch C4 and the fourth brake B4 is engaged, the state where only the fourth brake B4 out of the fourth clutch C4 and the fourth brake B4 is engaged, and the state where both the fourth clutch C4 and the fourth brake B4 are engaged, according to the position of the sleeve 80 in the axial direction L.

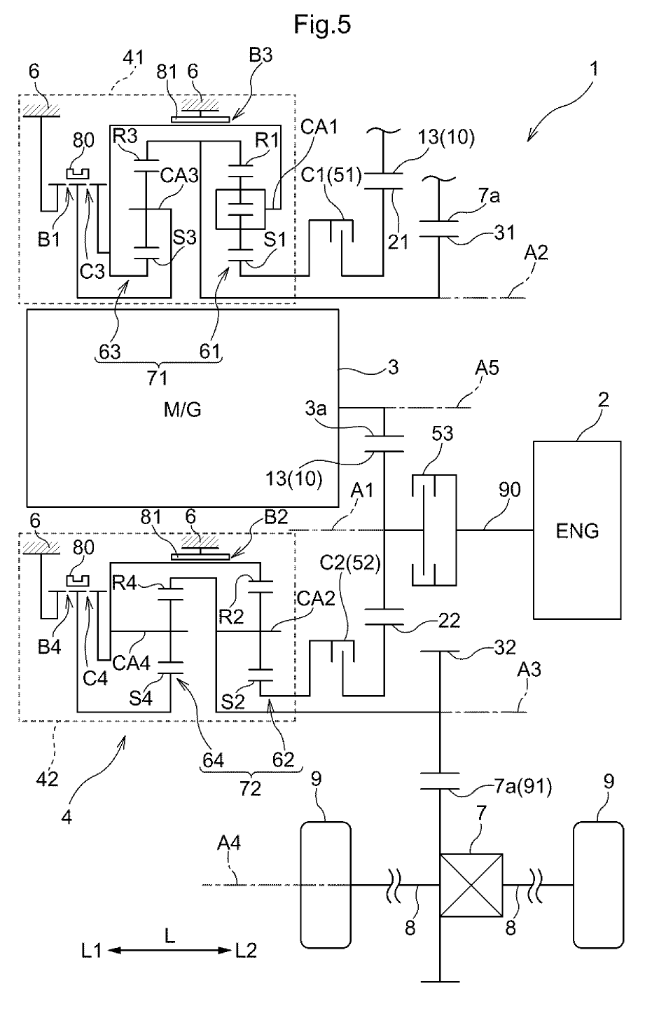

FIG. 1 illustrates the configuration in which all of the engagement devices included in the first speed change mechanism 41 and the second speed change mechanism 42 are meshing engagement devices. For example, however, as in an example shown in FIG. 5, band brakes having a brake band 81 may be used as the second brake B2 and the third brake B3. The brake band 81 is wound around the outer periphery of a cylindrical member that rotates with a rotary element to be braked. When the brake band 81 is tightened, the rotary element is held stationary with respect to the case 6. As can be seen from comparison between FIG. 5 and FIG. 1, changing the second brake B2 and the third brake B3 from the meshing engagement devices to the band brakes can reduce the size of the first speed change mechanism 41 and the second speed change mechanism 42 in the axial direction L as the space in the axial direction L where a single meshing engagement device is disposed is eliminated. In the example shown in FIG. 5, the first shift engagement devices that are disposed on the first side L1 in the axial direction with respect to the first gear mechanism 71 and control the differential state of the first gear mechanism 71 are the first brake B1 and the third clutch C3, and the second shift engagement devices that are disposed on the first side L1 in the axial direction with respect to the second gear mechanism 72 and control the differential state of the second gear mechanism 72 are the fourth brake B4 and the fourth clutch C4. The first shift engagement devices (B1, C3) are disposed at such positions that they overlap the second shift engagement devices (B4, C4) as viewed in the radial direction of the second speed change mechanism 42.

### Second Embodiment

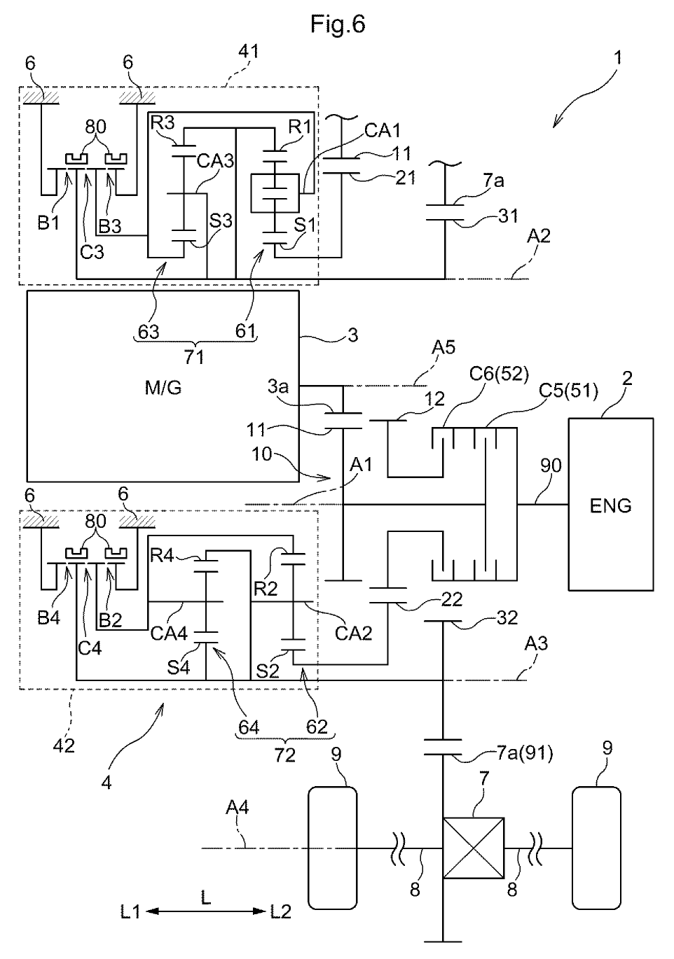

A second embodiment of the vehicle drive device will be described with reference to FIG. 6. The vehicle drive device of the present embodiment will be described mainly with respect to the differences from the first embodiment. Regarding the matters that are not specifically stated herein, the second embodiment is similar to the first embodiment. Like elements are denoted with the same reference characters as those of the first embodiment, and detailed description thereof will be omitted. In the second embodiment, a first drive gear 11 corresponds to the “drive gear.”

As shown in FIG. 6, in the present embodiment, the input gear mechanism 10 includes the first drive gear 11 meshing with the first driven gear 21 and a second drive gear 12 meshing with the second driven gear 22, instead of the common drive gear 13 of the first embodiment. In the example shown in FIG. 6, the first drive gear 11 is disposed on the first side L1 in the axial direction with respect to the second drive gear 12, and the first driven gear 21 is therefore disposed on the first side L1 in the axial direction with respect to the second driven gear 22. In the example shown in FIG. 6, the second drive gear 12 has a larger diameter than the first drive gear 11.

In the present embodiment, unlike the first embodiment, the first engagement device 51 and the second engagement device 52 are provided on a power transmission path between the input shaft 90 and the input gear mechanism 10. Specifically, the first engagement device 51 is formed by a fifth clutch C5 provided on a power transmission path between the input shaft 90 and the first drive gear 11 and couples or decouples the input shaft 90 to or from the first drive gear 11. The second engagement device 52 is formed by a sixth clutch C6 provided on a power transmission path between the input shaft 90 and the second drive gear 12 and couples or decouples the input shaft 90 to or from the second drive gear 12. In the present embodiment, since the positions of the first engagement device 51 and the second engagement device 52 are thus changed, the first sun gear S1 is coupled to the first driven gear 21 so as to rotate therewith, and the second sun gear S2 is coupled to the second driven gear 22 so as to rotate therewith.

In the present embodiment, the first engagement device 51 (the fifth clutch C5) and the second engagement device 52 (the sixth clutch C6) are disposed on the second side L2 in the axial direction with respect to the input gear mechanism 10 and coaxially with the input gear mechanism 10 (i.e., on the first axis A1). This can simplify the configurations about the second axis A2 on which the first speed change mechanism 41 is disposed and about the third axis A3 on which the second speed change mechanism 42 is disposed as compared to the case where the first engagement device 51 (the first clutch C1) is disposed on the second axis A2 and the second engagement device 52 (the second clutch C2) is disposed on the third axis A3 as in the first embodiment. In the present embodiment, both the first output gear 31 and the second output gear 32 are disposed so as to overlap at least one of the first engagement device 51 and the second engagement device 52 (in the example shown in FIG. 6, the second engagement device 52) as viewed in the radial direction R.

In the present embodiment as well, a plurality of odd speeds are established by the first speed change mechanism 41 and a plurality of even speeds are established by the second speed change mechanism 42 according to the operation table shown in FIG. 4 (in which the first clutch C1 is replaced with the fifth clutch C5 and the second clutch C2 is replaced with the sixth clutch C6). In the present embodiment, the internal combustion engine 2 can be disconnected from the wheels 9 by disengaging both the first engagement device 51 and the second engagement device 52. The vehicle drive device 1 according to the present embodiment therefore does not include the third engagement device 53 of the first embodiment. That is, in the present embodiment, both the first engagement device 51 and the second engagement device 52 are disengaged while in the electric drive mode.

In the present embodiment, a gear included in the input gear mechanism 10 and meshing with at least one of the first driven gear 21 and the second driven gear 22 serves as a drive gear (in the present embodiment, the first drive gear 11 or the second drive gear 12), and the output rotary member 3a of the rotating electrical machine 3 meshes with the drive gear (the first drive gear 11 or the second drive gear 12) or is coupled to the drive gear (the first drive gear 11 or the second drive gear 12) so as to rotate therewith. In the example shown in FIG. 6, the drive gear is the first drive gear 11, and the output rotary member 3a of the rotating electrical machine 3 meshes with the first drive gear 11. The drive gear may be the second drive gear 12 and the output rotary member 3a of the rotating electrical machine 3 may mesh with the second drive gear 12.

As described above, in the example shown in FIG. 6, the output rotary member 3a of the rotating electrical machine 3 meshes with the first drive gear 11. Accordingly, in the vehicle drive device 1 according to the present embodiment, the electric drive mode can be attained at only an odd speed that is established by the first speed change mechanism 41. When only the first engagement device 51 out of the first engagement device 51 and the second engagement device 52 has been engaged and an odd speed has been established by the first speed change mechanism 41, both torque of the internal combustion engine 2 and torque of the rotating electrical machine 3 can be transmitted to the output member 91 through the first speed change mechanism 41 to move the vehicle. When only the second engagement device 52 out of the first engagement device 51 and the second engagement device 52 has been engaged and an even speed has been established by the second speed change mechanism 42, torque of only the internal combustion engine 2 out of the internal combustion engine 2 and the rotating electrical machine 3 can be transmitted to the output member 91 through the second speed change mechanism 42. In this state as well, in the case where an odd speed has been established by the first speed change mechanism 41 in preparation for upshifting or downshifting, torque generated by the rotating electrical machine 3 (assist torque or regenerative torque) can be transmitted to the wheels 9 through the first speed change mechanism 41.

### Third Embodiment

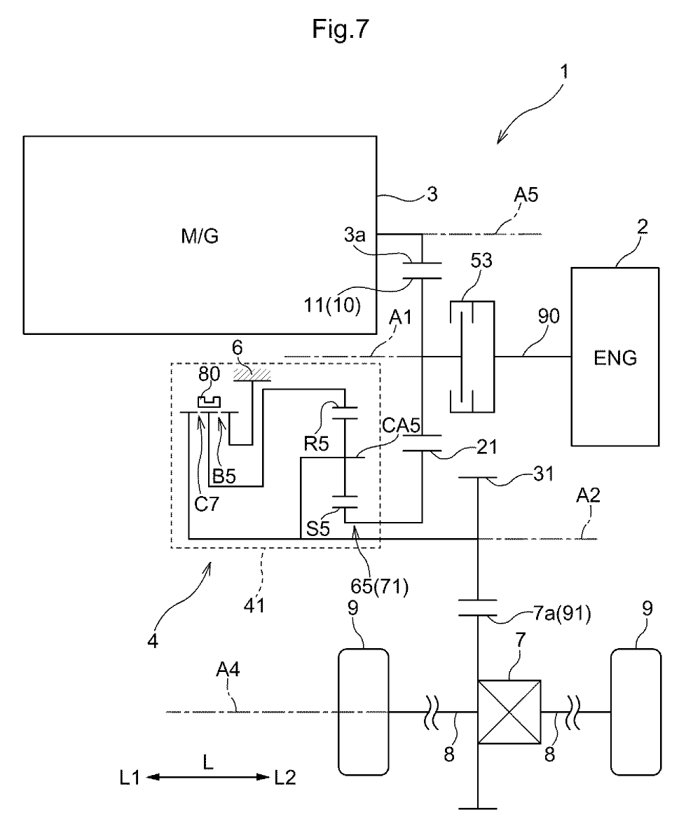

A third embodiment of the vehicle drive device will be described with reference to FIG. 7. The vehicle drive device of the present embodiment will be described mainly with respect to the differences from the first embodiment. Regarding the matters that are not specifically stated herein, the third embodiment is similar to the first embodiment. Like elements are denoted with the same reference characters as those of the first embodiment, and detailed description thereof will be omitted. In the third embodiment, the first driven gear 21 corresponds to the “driven gear,” and the first speed change mechanism 41 corresponds to the “speed change mechanism.”

As shown in FIG. 7, like the automatic transmission 4 of the first embodiment, the automatic transmission 4 of the present embodiment includes the input gear mechanism 10 to which a rotational driving force of the input shaft 90 is transmitted, the first driven gear 21 meshing with the input gear mechanism 10, and the first speed change mechanism 41 that shifts rotation of the first driven gear 21 to transmit the shifted rotation to the output member 91. However, unlike the automatic transmission 4 of the first embodiment, the automatic transmission 4 of the present embodiment does not include the second driven gear 22, the second speed change mechanism 42, the first engagement device 51, and the second engagement device 52.

In the present embodiment, the input gear mechanism 10 includes the first drive gear 11 meshing with the first driven gear 21. The output rotary member 3a of the rotating electrical machine 3 meshes with the first drive gear 11 at a different position in the circumferential direction from the first driven gear 21. In the present embodiment, no engagement device that selectively transmits rotation and a driving force is provided on a power transmission path between the first driven gear 21 and the first speed change mechanism 41, and the first driven gear 21 is coupled to the rotary element in the first speed change mechanism 41 which is drivingly coupled to the input gear mechanism 10 so that the first driven gear 21 rotates with the rotary element.

In the present embodiment, the first speed change mechanism 41 included in the automatic transmission 4 includes a single planetary gear mechanism (a fifth planetary gear mechanism 65), and the first gear mechanism 71 is formed by using this single planetary gear mechanism. Specifically, the fifth planetary gear mechanism 65 is a single-pinion type planetary gear mechanism. A sun gear of the fifth planetary gear mechanism 65 (a fifth sun gear S5) is coupled to the first driven gear 21 so as to rotate therewith, a carrier of the fifth planetary gear mechanism 65 (a fifth carrier CA5) is coupled to the first output gear 31 so as to rotate therewith. The first speed change mechanism 41 further includes a fifth brake B5 that selectively holds a ring gear of the fifth planetary gear mechanism 65 (a fifth ring gear R5) stationary with respect to the case 6, and a seventh clutch C7 that selectively couples the fifth carrier CA5 to the fifth ring gear R5.

In the present embodiment, the automatic transmission 4 is configured to be able to establish two forward shift speeds having different speed ratios. Specifically, with only the fifth brake B5 being engaged out of the fifth brake B5 and the seventh clutch C7, a shift speed (deceleration speed) is established at which rotation of the first driven gear 21 is reduced in speed and transmitted to the first output gear 31. Moreover, with only the seventh clutch C7 being engaged out of the fifth brake B5 and the seventh clutch C7, a shift speed (direct coupling speed) is established at which all of the rotary elements of the first speed change mechanism 41 (in the present embodiment, three rotary elements) rotate together at the same speed and rotation of the first driven gear 21 is transmitted to the first output gear 31 without being changed in speed. In the example shown in FIG. 7, both the fifth brake B5 and the seventh clutch C7 are meshing engagement devices whose engagement state is switched according to the position of the sleeve 80 in the axial direction L.

### OTHER EMBODIMENTS

Next, other embodiments of the vehicle drive device will be described.

(1) The first and second embodiments are described with respect to the configuration in which the first speed ratio and the second speed ratio have different values from each other and the third speed ratio and the fourth speed ratio have the same value. However, the present disclosure is not limited to such a configuration. The present disclosure may be configured so that the first speed ratio and the second speed ratio have the same value and the third speed ratio and the fourth speed ratio have different values from each other or so that the first speed ratio and the second speed ratio have different values from each other and the third speed ratio and the fourth speed ratio have different values from each other.

(2) The first and second embodiments are described with respect to the configuration in which the product of the first speed ratio and the third speed ratio and the product of the second speed ratio and the fourth speed ratio have different values from each other. However, the present disclosure is not limited to such a configuration. The present disclosure may be configured so that the product of the first speed ratio and the third speed ratio and the product of the second speed ratio and the fourth speed ratio are the same, in the case where all of a plurality of speed ratios that are attained by the first speed change mechanism 41 (the ratios of the rotational speed of the first driven gear 21 to the rotational speed of the first output gear 31) have different values from all of a plurality of speed ratios that are attained by the second speed change mechanism 42 (the ratios of the rotational speed of the second driven gear 22 to the rotational speed of the second output gear 32).

(3) The first and second embodiments are described with respect to the configuration in which both the minimum speed ratio that is attained by the first speed change mechanism 41 (the ratio of the rotational speed of the first driven gear 21 to the rotational speed of the first output gear 31) and the minimum speed ratio that is attained by the second speed change mechanism 42 (the ratio of the rotational speed of the second driven gear 22 to the rotational speed of the second output gear 32) are 1. However, the present disclosure is not limited to such a configuration. The present disclosure may be configured so that only one of the minimum speed ratio that is attained by the first speed change mechanism 41 and the minimum speed ratio that is attained by the second speed change mechanism 42 is 1 or so that both the minimum speed ratio that is attained by the first speed change mechanism 41 and the minimum speed ratio that is attained by the second speed change mechanism 42 are different from 1.

(4) Each of the above embodiments is described with respect to the configuration in which the output rotary member 3a of the rotating electrical machine 3 meshes with the drive gear (the common drive gear 13 in the first embodiment, the first drive gear 11 or the second drive gear 12 in the second embodiment, and the first drive gear 11 in the third embodiment). However, the present disclosure is not limited to such a configuration. The present disclosure may be configured so that the output rotary member 3a of the rotating electrical machine 3 and the drive gear are drivingly coupled via another transmission member (an idler gear etc.). For example, the output rotary member 3a of the rotating electrical machine 3 may mesh with the first driven gear 21 or the second driven gear 22 so that the output rotary member 3a of the rotating electrical machine 3 and the drive gear are drivingly coupled via the first driven gear 21 or the second driven gear 22.

(5) Each of the above embodiments is described with respect to the configuration in which the rotating electrical machine 3 is disposed on a different axis from the input gear mechanism 10. However, the present disclosure is not limited to such a configuration. The present disclosure may be configured so that the rotating electrical machine 3 is disposed coaxially with the input gear mechanism 10. In this case, for example, the output rotary member 3a of the rotating electrical machine 3 may be coupled to the drive gear (the common drive gear 13 in the first embodiment, the first drive gear 11 or the second drive gear 12 in the second embodiment, and the first drive gear 11 in the third embodiment) so as to rotate therewith. In this case, the output rotary member 3a may be a shaft member that rotates with the rotor of the rotating electrical machine 3 rather than such an output gear as described in each of the above embodiments.

(6) The first and second embodiments are described with respect to the configuration in which both the first output gear 31 and the second output gear 32 are disposed so as to overlap the third engagement device 53 as viewed in the radial direction R. However, the present disclosure is not limited to such a configuration. The present disclosure may be configured so that both the first output gear 31 and the second output gear 32 are disposed at such positions that they do not overlap the third engagement device 53 as viewed in the radial direction R (different positions in the axial direction L from the third engagement device 53).

(7) The first and second embodiments are described with respect to the configuration in which the first output gear 31 is disposed on the second side L2 in the axial direction with respect to the first speed change mechanism 41 and the second output gear 32 is disposed on the second side L2 in the axial direction with respect to the second speed change mechanism 42. However, the present disclosure is not limited to such a configuration. The present disclosure may be configured so that the first output gear 31 is disposed on the first side L1 in the axial direction with respect to the first speed change mechanism 41 and the second output gear 32 is disposed on the first side L1 in the axial direction with respect to the second speed change mechanism 42. Alternatively, the present disclosure may be configured so that the first output gear 31 is disposed in the region in the axial direction L where the first speed change mechanism 41 is disposed and the second output gear 32 is disposed in the region in the axial direction L where the second speed change mechanism 42 is disposed.

(8) The first embodiment is described with respect to the configuration in which the second engagement device 52 is disposed at such a position that it overlaps the first engagement device 51 as viewed in the radial direction of the first engagement device 51. However, the present disclosure is not limited to such a configuration. The present disclosure may be configured so that the second engagement device 52 is disposed at a different position in the axial direction L from the first engagement device 51 so as not to overlap the first engagement device 51 as viewed in the radial direction of the first engagement device 51.

(9) Each of the above embodiments is described with respect to the configuration in which the differential input gear 7a is used as the output member 91. However, the present disclosure is not limited to such a configuration. The present disclosure may be configured so that a gear mechanism (e.g., a counter gear mechanism) is provided on a power transmission path between the first and second speed change mechanisms 41, 42 and the differential gear unit 7 (the differential input gear 7a) and a gear included in this gear mechanism is used as the output member 91 (functions as the output member 91). In such a case, the output member 91 may separately include a gear meshing with the first output gear 31 and a gear meshing with the second output gear 32.

(10) The configurations of the first speed change mechanism 41 and the second speed change mechanism 42 described in the first and second embodiments are by way of example only, and the specific configurations of the first speed change mechanism 41 and the second speed change mechanism 42 (the type(s) of planetary gear mechanism to be used (single-pinion type, double-pinion type, Ravigneaux type, etc.), the number of planetary gear mechanisms to be used, the positions and configurations of the engagement devices with respect to the rotary elements, etc.) may be modified as appropriate. Similarly, the configuration of the first speed change mechanism 41 described in the third embodiment is by way of example only, and the specific configuration of the first speed change mechanism 41 may be modified as appropriate.

(11) The first and third embodiments are described with respect to the configuration in which the vehicle drive device 1 includes the third engagement device 53. However, the present disclosure is not limited to such a configuration. The present disclosure may be configured so that the vehicle drive device 1 does not include the third engagement device 53 and the input shaft 90 and the input gear mechanism 10 (the common drive gear 13 or the first drive gear 11) rotate together.

(12) The configurations disclosed in each of the above embodiments may be combined with the configurations disclosed in any of the other embodiments unless inconsistency arises (including combinations of the embodiments described as “other embodiments”). Regarding other configurations as well, the embodiments disclosed in the specification are by way of example only in all respects, and various modifications can be made as appropriate without departing from the spirit and scope of the present disclosure.

### SUMMARY OF EMBODIMENTS

The summary of the vehicle drive device described above will be presented.

A vehicle drive device (1) includes an input member (90) drivingly coupled to an internal combustion engine (2), an output member (91) drivingly coupled to wheels (9), a rotating electrical machine (3), and an automatic transmission (4). The automatic transmission (4) includes an input gear mechanism (10) to which a rotational driving force of the input member (90) is transmitted, a driven gear (21) meshing with the input gear mechanism (10), and a speed change mechanism (41) that shifts rotation of the driven gear (21) to transmit the shifted rotation to the output member (91), an output rotary member (3a) of the rotating electrical machine (3) is drivingly coupled to the input gear mechanism (10), the input gear mechanism (10) and the speed change mechanism (41) are separately disposed on two parallel axes (A1, A2). The speed change mechanism (41) is of a planetary gear type and is disposed on a first side (L1) in an axial direction, which is one side in the axial direction (L), with respect to the driven gear (21), the rotating electrical machine (3) is disposed at such a position that at least a part of the rotating electrical machine (3) overlaps the speed change mechanism (41) as viewed in a radial direction of the rotating electrical machine (3), and the rotating electrical machine (3) is disposed on the first side (L1) in the axial direction with respect to the input gear mechanism (10) so as to overlap the input gear mechanism (10) or a member that rotates with the input gear mechanism (10) as viewed in the axial direction (L).

According to this configuration, the rotating electrical machine (3) is disposed at such a position that at least a part of the rotating electrical machine (3) overlaps the speed change mechanism (41) as viewed in the radial direction of the rotating electrical machine (3), and the rotating electrical machine (3) is disposed on the first side (L1) in the axial direction with respect to the input gear mechanism (10) so as to overlap the input gear mechanism (10) or the member that rotates with the input gear mechanism (10) as viewed in the axial direction (L). An increase in overall device dimensions which is caused by disposing the rotating electrical machine (3) can be restrained in both the axial direction (L) and a direction perpendicular to the axial direction (L), whereby reduction in overall device size can be achieved.

More specifically, according to the above configuration, the speed change mechanism (41) disposed on the first side (L1) in the axial direction with respect to the driven gear (21) is a planetary gear type speed change mechanism. A configuration can thus be implemented in which no member for transmitting power between the axis (A1) on which the input gear mechanism (10) is disposed and the axis (A2) on which the speed change mechanism (41) is disposed is located on the first side (L1) in the axial direction with respect to the driven gear (21). This allows a space where at least a part of the rotating electrical machine (3) is disposed so as to overlap the speed change mechanism (41) as viewed in the radial direction of the rotating electrical machine (3) to be provided in a region which is located on the first side (L1) in the axial direction with respect to the input gear mechanism (10) and in which the rotating electrical machine (3) overlaps the input gear mechanism (10) or the member that rotates with the input gear mechanism (10) as viewed in the axial direction (L). That is, even in the case where the rotating electrical machine (3) is disposed so as to overlap the input gear mechanism (10) or the member that rotates with the input gear mechanism (10) as viewed in the axial direction (L) in order to reduce the overall device dimension in the direction perpendicular to the axial direction (L), the rotating electrical machine (3) can be disposed at such a position that at least a part of the rotating electrical machine (3) overlaps the speed change mechanism (41) as viewed in the radial direction of the rotating electrical machine (3). Reduction in overall device length in the axial direction (L) can thus be achieved.

As described above, according to the above configuration, the vehicle drive device (1) can be implemented which can restrain an increase in device size which is caused by including the rotating electrical machine (3).

It is preferable that the speed change mechanism (41) be a first speed change mechanism (41) and the driven gear (21) be a first driven gear (21), the automatic transmission (4) further include a second driven gear (22) meshing with the input gear mechanism (10), a second speed change mechanism (42) that shifts rotation of the second driven gear (22) to transmit the shifted rotation to the output member (91), a first engagement device (51) that couples or decouples the input member (90) to or from the first speed change mechanism (41), and a second engagement device (52) that couples or decouples the input member (90) to or from the second speed change mechanism (42), the second speed change mechanism (42) be disposed on a different axis (A3) from the input gear mechanism (10) and the first speed change mechanism (41), the second speed change mechanism (42) be of a planetary gear type and be disposed on the first side (L1) in the axial direction with respect to the second driven gear (22), and the rotating electrical machine (3) be disposed at such a position that at least a part of the rotating electrical machine (3) overlaps each of the first speed change mechanism (41) and the second speed change mechanism (42) as viewed in the radial direction of the rotating electrical machine (3).

According to this configuration, even in the case where the automatic transmission (4) includes two speed change mechanisms (41, 42) and two engagement devices (51, 52) for switching between the two speed change mechanisms (41, 42), an increase in device size which is caused by including the rotating electrical machine (3) can be restrained.

More specifically, according to the above configuration, the first speed change mechanism (41) is disposed on the first side (L1) in the axial direction with respect to the first driven gear (21) meshing with the input gear mechanism (10), and the second speed change mechanism (42) is disposed on the first side (L1) in the axial direction (that is, on the side on which the first speed change mechanism (41) is disposed with respect to the first driven gear (21) in the axial direction (L)) with respect to the second driven gear (22) meshing with the input gear mechanism (10). The first speed change mechanism (41) and the second speed change mechanism (42) which are separately disposed on different axes from each other can thus be disposed so that a region in the axial direction (L) where the first speed change mechanism (41) is disposed and a region in the axial direction (L) where the second speed change mechanism (42) is disposed overlap each other. The length in the axial direction (L) of a space occupied by the automatic transmission (4) can thus be reduced accordingly.

Moreover, according to the above configuration, both the first speed change mechanism (41) disposed on the first side (L1) in the axial direction with respect to the first driven gear (21) and the second speed change mechanism (42) disposed on the first side (L1) in the axial direction with respect to the second driven gear (22) are planetary gear type speed change mechanisms. A configuration can this be implemented in which no member for transmitting power between the axis (A1) on which the input gear mechanism (10) is disposed and the axis (A2) on which the first speed change mechanism (41) is disposed is located on the first side (L1) in the axial direction with respect to the first driven gear (21) and no member for transmitting power between the axis (A1) on which the input gear mechanism (10) is disposed and the axis (A3) on which the second speed change mechanism (42) is disposed is located on the first side (L1) in the axial direction with respect to the second driven gear (22). This allows a space where at least a part of the rotating electrical machine (3) is disposed so as to overlap each of the first speed change mechanism (41) and the second speed change mechanism (42) as viewed in the radial direction of the rotating electrical machine (3) to be provided in a region which is located on the first side (L1) in the axial direction with respect to the input gear mechanism (10) and in which the rotating electrical machine (3) overlaps the input gear mechanism (10) or the member that rotates with the input gear mechanism (10) as viewed in the axial direction (L). That is, even in the case where the rotating electrical machine (3) is disposed so as to overlap the input gear mechanism (10) or the member that rotates with the input gear mechanism (10) as viewed in the axial direction (L) in order to reduce the overall device dimension in the direction perpendicular to the axial direction (L), the rotating electrical machine (3) can be disposed at such a position that at least a part of the rotating electrical machine (3) overlaps each of the first speed change mechanism (41) and the second speed change mechanism (42) as viewed in the radial direction of the rotating electrical machine (3). Reduction in overall device length in the axial direction (L) can thus be achieved.

In the configuration in which the automatic transmission (4) includes the first speed change mechanism (41) and the second speed change mechanism (42) as described above, it is preferable that the input gear mechanism (10) include a common drive gear (13) meshing with both the first driven gear (21) and the second driven gear (22), the first engagement device (51) couple or decouple the first driven gear (21) to or from the first speed change mechanism (41), and the second engagement device (52) couple or decouple the second driven gear (22) to or from the second speed change mechanism (42).

According to this configuration, a space in the axial direction (L) which is occupied by the input gear mechanism (10) can be reduced as compared to the case where the input gear mechanism (10) separately includes a gear meshing with the first driven gear (21) and a gear meshing with the second driven gear (22). The length in the axial direction (L) of a portion where the input gear mechanism (10) and the rotating electrical machine (3) can be reduced, whereby reduction in overall device size in the axial direction (L) can be achieved. Moreover, since the first driven gear (21) and the second driven gear (22) can be disposed at the same position in the axial direction (L), it is easier to increase the extent to which a region in the axial direction (L) where the first speed change mechanism (41) for shifting rotation of the first driven gear (21) is disposed and a region in the axial direction (L) where the second speed change mechanism (42) for shifting rotation of the second driven gear (22) is disposed overlap each other. Reduction in overall device size in the axial direction (L) can be achieved in this regard as well.

Alternatively, it is also preferable that the input gear mechanism (10) include a first drive gear (11) meshing with the first driven gear (21) and a second drive gear (12) meshing with the second driven gear (22), the first engagement device (51) couple or decouple the input member (90) to or from the first drive gear (11), and the second engagement device (52) couple or decouple the input member (90) to or from the second drive gear (12).

According to this configuration, it is easier to individually set a speed ratio between the input gear mechanism (10) and the first speed change mechanism (41) and a speed ratio between the input gear mechanism (10) and the second speed change mechanism (42), as compared to the case where the input gear mechanism (10) includes a gear meshing with both the first driven gear (21) and the second driven gear (22). According to the above configuration, both the first engagement device (51) and the second engagement device (52) for selecting to which of the first speed change mechanism (41) and the second speed change mechanism (42) torque from the input member (90) is to be transmitted can be disposed coaxially with, e.g., the input gear mechanism (10). This can simplify the configurations about the axes on which the first speed change mechanism (41) and the second speed change mechanism (42) are disposed.

It is preferable that a gear included in the input gear mechanism (10) and meshing with at least one of the first driven gear (21) and the second driven gear (22) serve as a drive gear (11, 13) and the output rotary member (3a) of the rotating electrical machine (3) mesh with the drive gear (11, 13) or be coupled to the drive gear (11, 13) so as to rotate therewith.

According to this configuration, the drive gear (11, 13) for inputting rotation of the input member (90) to the speed change mechanism (41, 42) can be used to apply output torque of the rotating electrical machine (3) to the speed change mechanism (41, 42). The configuration of the vehicle drive device (1) can therefore be simplified and reduction in overall device size can be achieved as compared to the case where a gear for inputting output torque of the rotating electrical machine (3) to the speed change mechanism (41, 42) is provided in addition to the drive gear (11, 13). According to the above configuration, output torque of the rotating electrical machine (3) can be transmitted to the wheels (9) via the automatic transmission (4) by allowing the automatic transmission (4) to shift rotation of the drive gear (11, 13) to transmit the shifted rotation to the output member (91). A hybrid drive mode in which both torque of the internal combustion engine (2) and torque of the rotating electrical machine (3) are transmitted to the wheels (9) to move the vehicle and an electric drive mode in which only torque of the rotating electrical machine (3) is transmitted to the wheels (9) to move the vehicle can be appropriately attained.

It is preferable that both a minimum speed ratio that is attained by the first speed change mechanism (41) and a minimum speed ratio that is attained by the second speed change mechanism (42) be 1 and a product of a first speed ratio and a third speed ratio and a product of a second speed ratio and a fourth speed ratio have different values from each other, the first speed ratio being a speed ratio between the input gear mechanism (10) and the first speed change mechanism (41), the second speed ratio being a speed ratio between the input gear mechanism (10) and the second speed change mechanism (42), the third speed ratio being a speed ratio between the first speed change mechanism (41) and the output member (91), and the fourth speed ratio being a speed ratio between the second speed change mechanism (42) and the output member (91).

The minimum speed ratios that are attained by the first speed change mechanism (41) and the second speed change mechanism (42) are typically attained for a longer period of time while the vehicle is moving than the other speed ratios that are attained by the first speed change mechanism (41) and the second speed change mechanism (42), and thus greatly affect energy efficiency of the vehicle drive device (1). According to the above configuration, for both the first speed change mechanism (41) and the second speed change mechanism (42), the minimum speed ratio is 1 at which the speed change mechanism (41, 42) has maximum power transmission efficiency. Accordingly, high power transmission efficiency between the input gear mechanism (10) and the output member (91) can be achieved with the minimum speed ratio being attained, and the energy efficiency of the vehicle drive device (1) can be improved. According to the above configuration, the product of the first speed ratio and the third speed ratio and the product of the second speed ratio and the fourth speed ratio have different values from each other. Therefore, even when both the minimum speed ratio that is attained by the first speed change mechanism (41) and the minimum speed ratio that is attained by the second speed change mechanism (42) are 1, the speed ratio between the input gear mechanism (10) and the output member (91) can be varied between when the minimum speed ratio has been attained by the first speed change mechanism (41) and when the minimum speed ratio has been attained by the second speed change mechanism (42).

It is preferable that a third speed ratio and a fourth speed ratio have the same value, the third speed ratio being the speed ratio between the first speed change mechanism (41) and the output member (91), and the fourth speed ratio being the speed ratio between the second speed change mechanism (42) and the output member (91).

According to this configuration, a first transmission member (a gear etc.) that transmits power between a rotary element in the first speed change mechanism (41) which is drivingly coupled to the output member (91) and the output member (91) and a second transmission member (a gear etc.) that transmits power between a rotary element in the second speed change mechanism (42) which is drivingly coupled to the output member (91) and the output member (91) can be a common part. Unlike this configuration, in the case where the third speed ratio is different from the fourth speed ratio, different kinds of transmission members (e.g., gears of different diameters from each other) need to be used as the first transmission member and the second transmission member which are required to transmit relatively large torque as the rotational speed is reduced by the automatic transmission (4). This may cause an increase in manufacturing cost of the vehicle drive device (1) because, for example, as the number of kinds of transmission members increases, the number of items that need to be verified in order to ensure that the first transmission member and the second transmission member have required strength is increased. On the other hand, according to the above configuration, since the first transmission member and the second transmission member can be a common part, the manufacturing cost of the vehicle drive device (1) can be reduced.

According to the above configuration, since the third speed ratio and the fourth speed ratio have the same value, the speed ratio between the input gear mechanism (10) and the output member (91) can be changed by changing the common speed ratio, namely the third speed ratio and the fourth speed ratio, without changing the speed ratio step in each combination of adjacent shift speeds (the ratio of speed ratio between adjacent shift speeds). It is therefore easier to change the speed ratio between the input gear mechanism (10) and the output member (91) according to the type of vehicle on which the vehicle drive device (1) is to be mounted etc.

It is preferable that the second speed change mechanism (42) be disposed at such a position that the second speed change mechanism (42) overlaps the first speed change mechanism (41) as viewed in a radial direction of the first speed change mechanism (41).

According to this configuration, the first speed change mechanism (41) and the second speed change mechanism (42) can be disposed so that a region in the axial direction (L) where the first speed change mechanism (41) is disposed and a region in the axial direction (L) where the second speed change mechanism (42) is disposed overlap each other. The length in the axial direction (L) of the space occupied by the automatic transmission (4) can thus be reduced, and reduction in overall device size in the axial direction (L) can be achieved.

In the vehicle drive device (1) with each configuration described above, it is preferable that the rotating electrical machine (3) be disposed on a different axis from the input gear mechanism (10), the output rotary member (3a) of the rotating electrical machine (3) mesh with the input gear mechanism (10) at a different position in a circumferential direction from the driven gear (21), and rotation of the rotating electrical machine (3) be reduced in speed and transmitted to the input gear mechanism (10).

According to this configuration, a smaller rotating electrical machine (3) can be used to obtain the same output torque as compared to the case where rotation of the rotating electrical machine (3) is transmitted at the same speed or at an increased speed to the input gear mechanism (10). Further reduction in overall device size can thus be achieved.

It is preferable that the rotating electrical machine (3) be disposed so as to overlap a shaft center (A1) of the input gear mechanism (10) as viewed in the axial direction (L).

According to this configuration, the overall device dimension in the direction perpendicular to the axial direction (L) can be easily reduced.

It is preferable that no parallel axis gear type speed change mechanism capable of changing a speed ratio be provided on the first side (L1) in the axial direction with respect to the input gear mechanism (10).

According to this configuration, a space where the rotating electrical machine (3) is disposed so that a region in the axial direction (L) where the rotating electrical machine (3) is disposed overlaps a region in the axial direction (L) where the speed change mechanism (41) is disposed can be more easily provided in a region which is located on the first side (L1) in the axial direction with respect to the input gear mechanism (10) and in which the rotating electrical machine (3) overlaps the input gear mechanism (10) or the member that rotates with the input gear mechanism (10) as viewed in the axial direction (L), as compared to the case where a parallel axis gear type speed change mechanism capable of changing a speed ratio is provided on the first side (L1) in the axial direction with respect to the input gear mechanism (10). Further reduction in overall device length in the axial direction (L) can be achieved.

The vehicle drive device according to the present disclosure needs only to have at least one of the effects described above.

1. A vehicle drive device comprising
an input drivingly coupled to an internal combustion engine,
an output drivingly coupled to wheels,
a rotating electrical machine, and
an automatic transmission, wherein
the automatic transmission includes an input gear to which a rotational driving force of the input is transmitted, a driven gear meshing with the input gear and a speed change mechanism that shifts rotation of the driven gear to transmit the shifted rotation to the output,
an output rotary member of the rotating electrical machine is drivingly coupled to the input gear,
the input gear and the speed change mechanism are separately disposed on two parallel axes,
the speed change mechanism is of a planetary gear type and is disposed on a first side in an axial direction, which is one side in the axial direction, with respect to the driven gear,
the rotating electrical machine is disposed at such a position that at least a part of the rotating electrical machine overlaps the speed change mechanism as viewed in a radial direction of the rotating electrical machine, and
the rotating electrical machine is disposed on the first side in the axial direction with respect to the input gear so as to overlap the input gear or a member that rotates with the input gear as viewed in the axial direction.

2. The vehicle drive device according to claim 1, wherein
the speed change mechanism is a first speed change mechanism and the driven gear is a first driven gear,
the automatic transmission further includes a second driven gear meshing with the input gear, a second speed change mechanism that shifts rotation of the second driven gear to transmit the shifted rotation to the output, a first engagement device that couples or decouples the input to or from the first speed change mechanism, and a second engagement device that couples or decouples the input to or from the second speed change mechanism,
the second speed change mechanism is disposed on a different axis from the input gear and the first speed change mechanism,
the second speed change mechanism is of a planetary gear type and is disposed on the first side in the axial direction with respect to the second driven gear, and
the rotating electrical machine is disposed at such a position that at least a part of the rotating electrical machine overlaps each of the first speed change mechanism and the second speed change mechanism as viewed in the radial direction of the rotating electrical machine.

3. The vehicle drive device according to claim 2, wherein
the input gear includes a common drive gear meshing with both the first driven gear and the second driven gear,
the first engagement device couples or decouples the first driven gear to or from the first speed change mechanism, and
the second engagement device couples or decouples the second driven gear to or from the second speed change mechanism.

4. The vehicle drive device according to claim 2, wherein
the input gear includes a first drive gear meshing with the first driven gear and a second drive gear meshing with the second driven gear,
the first engagement device couples or decouples the input to or from the first drive gear, and
the second engagement device couples or decouples the input to or from the second drive gear.

5. The vehicle drive device according to claim 2, wherein
a gear included in the input gear and meshing with at least one of the first driven gear and the second driven gear serves as a drive gear, and the output rotary member of the rotating electrical machine meshes with the drive gear or is coupled to the drive gear so as to rotate therewith.

6. The vehicle drive device according to claim 2, wherein
both a minimum speed ratio that is attained by the first speed change mechanism and a minimum speed ratio that is attained by the second speed change mechanism are 1, and
a product of a first speed ratio and a third speed ratio and a product of a second speed ratio and a fourth speed ratio have different values from each other, the first speed ratio being a speed ratio between the input gear and the first speed change mechanism, the second speed ratio being a speed ratio between the input gear and the second speed change mechanism, the third speed ratio being a speed ratio between the first speed change mechanism and the output, and the fourth speed ratio being a speed ratio between the second speed change mechanism and the output.

7. The vehicle drive device according to claim 2, wherein
a third speed ratio and a fourth speed ratio have the same value, the third speed ratio being the speed ratio between the first speed change mechanism and the output, and the fourth speed ratio being the speed ratio between the second speed change mechanism and the output.

8. The vehicle drive device according to claim 2, wherein
the second speed change mechanism is disposed at such a position that the second speed change mechanism overlaps the first speed change mechanism as viewed in a radial direction of the first speed change mechanism.

9. The vehicle drive device according to claim 1, wherein
the rotating electrical machine is disposed on a different axis from the input gear,
the output rotary member of the rotating electrical machine meshes with the input gear at a different position in a circumferential direction from the driven gear, and
rotation of the rotating electrical machine is reduced in speed and transmitted to the input gear.

10. The vehicle drive device according to claim 1, wherein
the rotating electrical machine is disposed so as to overlap a shaft center of the input gear as viewed in the axial direction.

11. The vehicle drive device according to claim 1, wherein
no parallel axis gear type speed change mechanism capable of changing a speed ratio is provided on the first side in the axial direction with respect to the input gear.

12. The vehicle drive device according to claim 3, wherein
a gear included in the input gear and meshing with at least one of the first driven gear and the second driven gear serves as a drive gear, and the output rotary member of the rotating electrical machine meshes with the drive gear or is coupled to the drive gear so as to rotate therewith.

13. The vehicle drive device according to claim 12, wherein
both a minimum speed ratio that is attained by the first speed change mechanism and a minimum speed ratio that is attained by the second speed change mechanism are 1, and
a product of a first speed ratio and a third speed ratio and a product of a second speed ratio and a fourth speed ratio have different values from each other, the first speed ratio being a speed ratio between the input gear and the first speed change mechanism, the second speed ratio being a speed ratio between the input gear and the second speed change mechanism, the third speed ratio being a speed ratio between the first speed change mechanism and the output, and the fourth speed ratio being a speed ratio between the second speed change mechanism and the output.

14. The vehicle drive device according to claim 6, wherein
a third speed ratio and a fourth speed ratio have the same value, the third speed ratio being the speed ratio between the first speed change mechanism and the output, and the fourth speed ratio being the speed ratio between the second speed change mechanism and the output.

15. The vehicle drive device according to claim 13, wherein
a third speed ratio and a fourth speed ratio have the same value, the third speed ratio being the speed ratio between the first speed change mechanism and the output, and the fourth speed ratio being the speed ratio between the second speed change mechanism and the output.

16. The vehicle drive device according to claim 3, wherein
the second speed change mechanism is disposed at such a position that the second speed change mechanism overlaps the first speed change mechanism as viewed in a radial direction of the first speed change mechanism.

17. The vehicle drive device according to claim 15, wherein
the second speed change mechanism is disposed at such a position that the second speed change mechanism overlaps the first speed change mechanism as viewed in a radial direction of the first speed change mechanism.

18. The vehicle drive device according to claim 17, wherein
the rotating electrical machine is disposed on a different axis from the input gear,
the output rotary member of the rotating electrical machine meshes with the input gear at a different position in a circumferential direction from the driven gear, and
rotation of the rotating electrical machine is reduced in speed and transmitted to the input gear.

19. The vehicle drive device according to claim 18, wherein
the rotating electrical machine is disposed so as to overlap a shaft center of the input gear as viewed in the axial direction.

20. The vehicle drive device according to claim 19, wherein
no parallel axis gear type speed change mechanism capable of changing a speed ratio is provided on the first side in the axial direction with respect to the input gear.
